(19) United States
(12) Patent Application Publication
(10) Pub. No.: US 2025/0103272 A1
(43) Pub. Date: Mar. 27, 2025

(54) Calibrating Acoustic Instruments for a Physical Environment

(71) Applicant: Apple Inc., Cupertino, CA (US)

(72) Inventors: Camellia G. Boutros, San Francisco, CA (US); Danielle M. Price, Los Gatos, CA (US); Hana Z. Wang, Novato, CA (US); Ronald J. Guglielmone, JR., Redwood City, CA (US); Sam D. Smith, San Francisco, CA (US); Xavier Prospero, San Francisco, CA (US)

(21) Appl. No.: 18/893,503

(22) Filed: Sep. 23, 2024

Related U.S. Application Data
(60) Provisional application No. 63/540,416, filed on Sep. 26, 2023.

(51) Int. Cl. G06F 3/16; G09G 3/00; G10K 11/178

(52) U.S. Cl. CPC G06F 3/162; G09G 3/001; G10K 11/17823; G10K 11/17827; G10K 11/17873; G10K 11/17885; G09G 2320/0626; G09G 2360/144; G10K 2210/1081; G10K 2210/3027; G10K 2210/3056; G10K 2210/505

(57) ABSTRACT

A method includes measuring an environmental parameter that indicates a sensory condition at a location of an electronic device within a physical environment. The method includes determining whether the environmental parameter is within an acceptable range. The method includes, in response to determining that the environmental parameter is not within the acceptable range, triggering presentation of augmented content in order to enhance the sensory condition at the location of the electronic device.

### CROSS-REFERENCE TO RELATED APPLICATION

This application claims the benefit of U.S. Provisional Patent App. No. 63/540,416, filed on Sep. 26, 2023, which is incorporated by reference in its entirety.

### TECHNICAL FIELD

The present disclosure generally relates to calibrating acoustic instruments for a physical environment.

### BACKGROUND

Some devices can be used to calibrate instruments that produce sounds. Calibrating the instruments often requires moving the instruments within an environment. Some instruments are heavy and difficult to move. Some instruments are delicate and susceptible to damage upon being moved.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1N are diagrams of an example operating environment in accordance with some implementations.

FIG. 2 is a diagram of an acoustic configuration system in accordance with some implementations.

FIG. 3 is a flowchart representation of a method of configuring acoustic instruments in accordance with some implementations.

FIG. 4 is a block diagram of a device that utilizes virtual acoustic instruments to configure corresponding physical acoustic instruments in accordance with some implementations.

FIGS. 5A-5D are diagrams of another example operating environment in accordance with some implementations.

FIG. 6 is a diagram of an augmented content presentation system in accordance with some implementations.

FIG. 7 is a flowchart representation of a method of presenting augmented content in accordance with some implementations.

FIG. 8 is a block diagram of a device that presents augmented content in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for utilizing virtual acoustic instruments to configure corresponding physical acoustic instruments. In various implementations, a method is performed at an electronic device including a non-transitory memory, one or more processors, a display and an image sensor. In some implementations, the method includes displaying, on the display, virtual acoustic instruments as being overlaid onto a pass-through of a physical environment. In some implementations, the method includes performing, based on respective characteristics of the virtual acoustic instruments, an acoustic simulation in order to generate estimated acoustic parameters for respective locations within the physical environment. In some implementations, the method includes displaying, on the display, an indication of the estimated acoustic parameters.

Various implementations disclosed herein include devices, systems, and methods for augmenting a portion of a physical environment based on a sensory condition of the portion of the physical environment. In various implementations, a method is performed at an electronic device including a non-transitory memory, one or more processors, a display and an image sensor. In some implementations, the method includes measuring an environmental parameter that indicates a sensory condition at a location of the electronic device within a physical environment. In some implementations, the method includes determining whether the environmental parameter is within an acceptable range. In some implementations, the method includes, in response to determining that the environmental parameter is not within the acceptable range, triggering presentation of augmented content in order to enhance the sensory condition at the location of the electronic device.

In accordance with some implementations, a device includes one or more processors, a plurality of sensors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

It can be difficult to calibrate acoustic instruments for a live performance prior to the live performance. For example, some acoustic instruments may be heavy (e.g., a 200 lb. amplifier) and it may be difficult to move heavy acoustic instruments to different locations within a physical environment in order to determine suitable locations for heavy acoustic instruments. Some acoustic instruments may be delicate (e.g., a musical instrument such as a cello) and it may be difficult to move delicate acoustic instruments to different locations within the physical environment in order to determine suitable locations for delicate instruments.

Additionally, calibrating acoustic instruments without an audience may result in a calibration that does not account for the audience. For example, when the physical environment has audience members, the audience members may make sound (e.g., by clapping, talking with each other, singing, screaming, etc.) and the calibration has to account for the sound that the audience members will make. Moreover, audible signals generated by some of the acoustic instruments may reflect off the audience members and calibrating the acoustic instruments without audience members may not account for the reflection of audible signals off the audience members.

The present disclosure provides methods, systems, and/or devices for providing a user interface that allows a user to overlay virtual acoustic instruments onto a pass-through of a physical environment, perform an acoustic simulation based on the virtual acoustic instruments and view a result of the acoustic simulation in order to properly calibrate corresponding physical acoustic instruments. Calibrating the physical instruments based on the acoustic simulation requires fewer adjustments to the calibration of the physical instruments thereby reducing a number of user inputs that correspond to adjusting the calibration of the physical instruments. Reducing a number of calibration-adjusting user inputs tends to enhance operability of an electronic device by reducing utilization of resources (e.g., processing resources, memory resources and/or power resources) associated with receiving, interpreting, and acting upon the calibration-adjusting user inputs. For example, if the user is using a battery-operated device to calibrate the physical instruments, providing fewer calibration-adjusting user inputs may prolong a battery of the battery-operated device.

While presenting a pass-through of a physical environment, a device provides a user interface that allows a user to overlay virtual representations of acoustic instruments onto the pass-through of the physical environment. The user interface allows the user to place virtual musical instruments, virtual microphones, virtual displays and/or virtual speakers throughout the pass-through of the physical environment. Additionally, the user interface allows the user to overlay virtual people (e.g., virtual audience members and/or virtual performers) onto the pass-through of the physical environment.

After the user overlays virtual acoustic instruments and virtual audience members onto the pass-through of the physical environment, the device performs an acoustic simulation in order to generate estimated acoustic parameters for various locations within the physical environment. The estimated acoustic parameters may include estimated sound levels, estimated frequency responses, estimated sound quality values, etc. at various different locations within the physical environment. Performing the acoustic simulation may include generating an acoustic mesh of the physical environment. The acoustic mesh takes into account acoustic properties of the physical environment (e.g., absorption levels or reflection levels of materials of the physical environment). The acoustic simulation is a function of respective locations of the virtual acoustic instruments, respective locations of virtual audience members and a numerosity of the virtual audience members.

The device displays an indication of the estimated acoustic parameters. For example, the device can virtually color areas of the physical environment in green when their estimated acoustic parameters are within an acceptable range, virtually color areas of the physical environment in yellow when their estimated acoustic parameters are close to an edge of the acceptable range, and virtually color areas of the physical environment in red when their estimated acoustic parameters are outside the acceptable range. For example, areas where the estimated sound level is lower than an acceptable sound level can be shown in red. As another example, areas where an estimated reverberation is greater than an acceptable reverberation can be shown in red.

The device can provide calibration recommendations in order to improve the estimated acoustic parameters. The calibration recommendations may include recommended placement locations for some of the acoustic instruments. For example, the calibration recommendations may include a recommended placement location for a speaker in order to increase a sound level in a particular area of the physical environment from an unacceptable sound level to an acceptable sound level. As another example, the calibration recommendations may include lowering a gain of one of the microphones in order to reduce an estimated reverberation in an area. As another example, the calibration recommendations may include recommended EQ. For example, the calibration recommendations may include a recommended EQ treatment such as a recommendation to apply a filter (e.g., a low pass filter, a high pass filter, a band pass filter, etc.) in order to reduce an impact of the interfering frequencies.

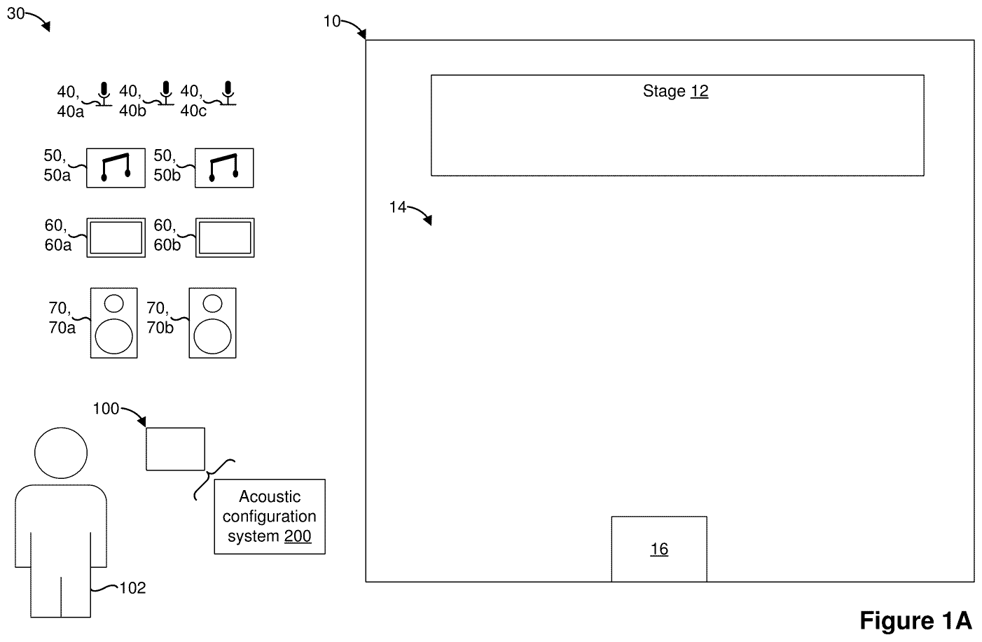

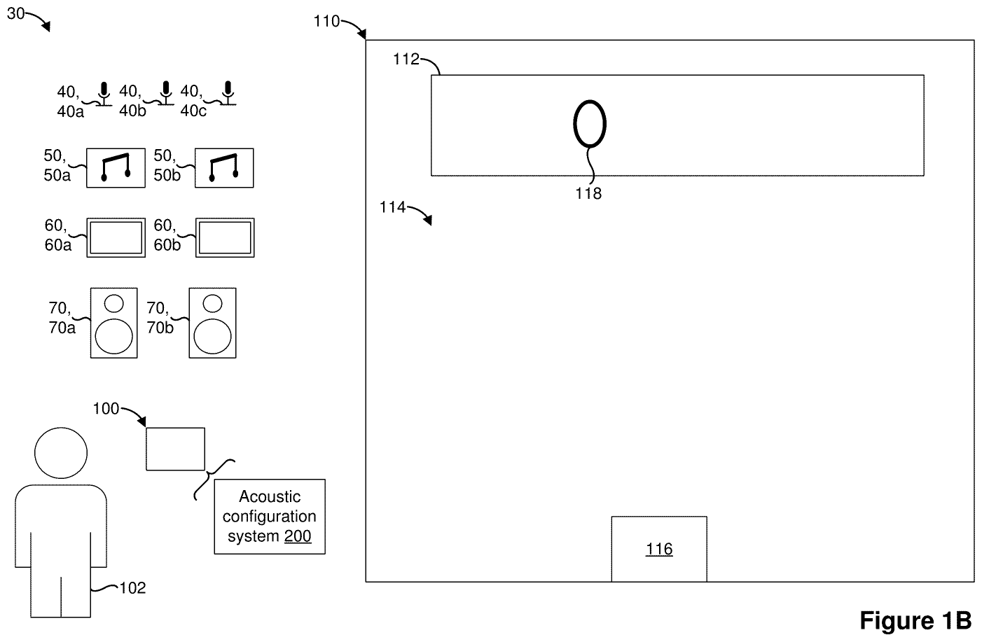

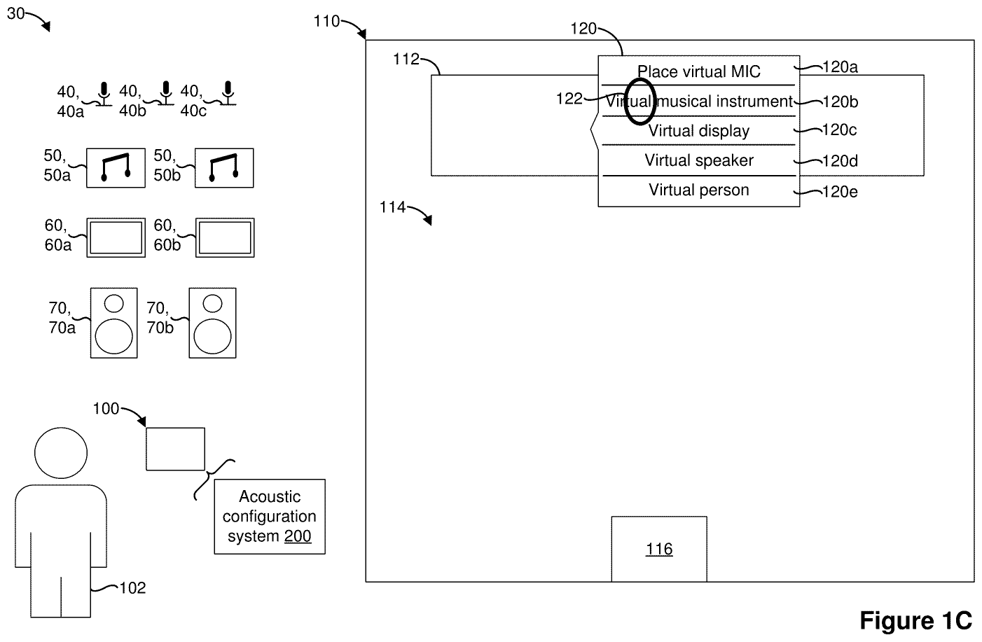

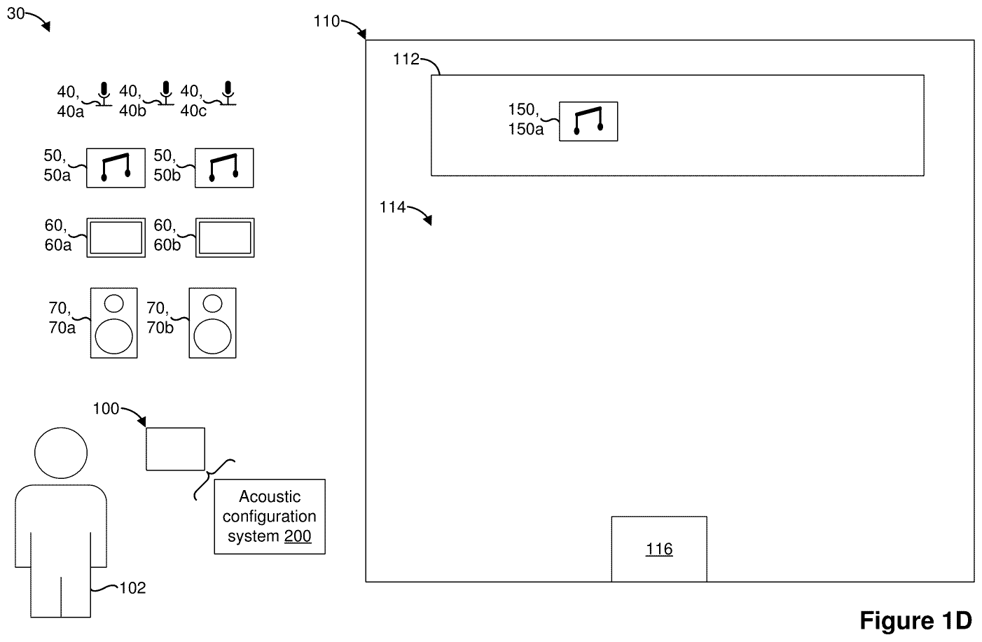

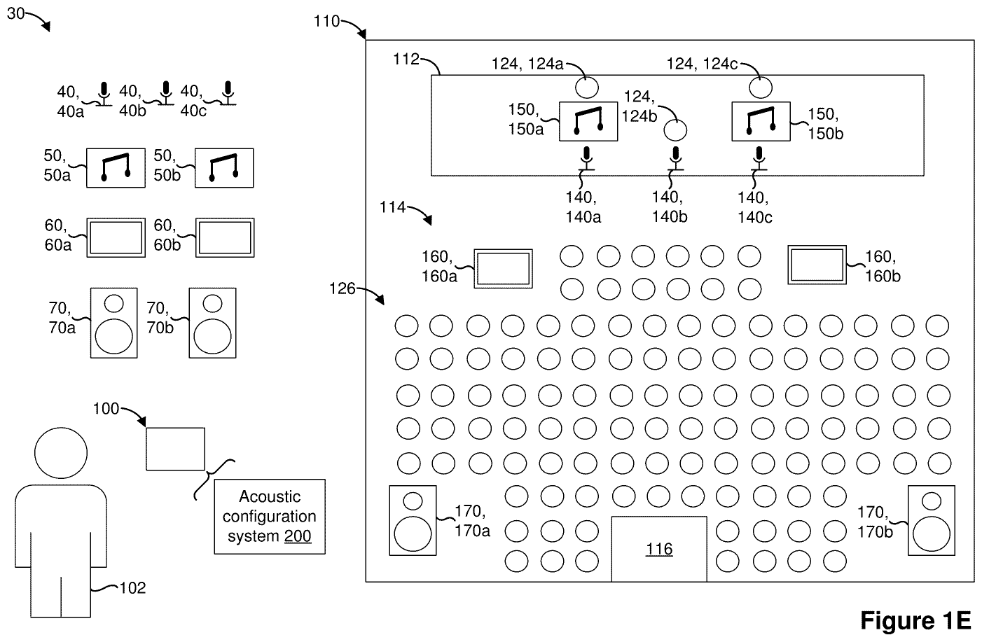

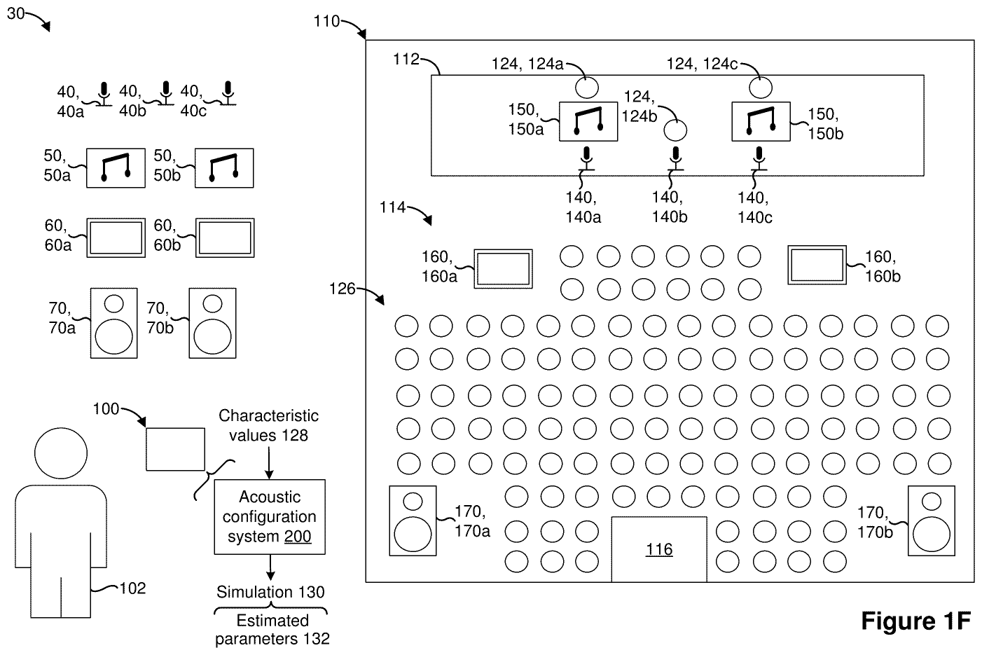

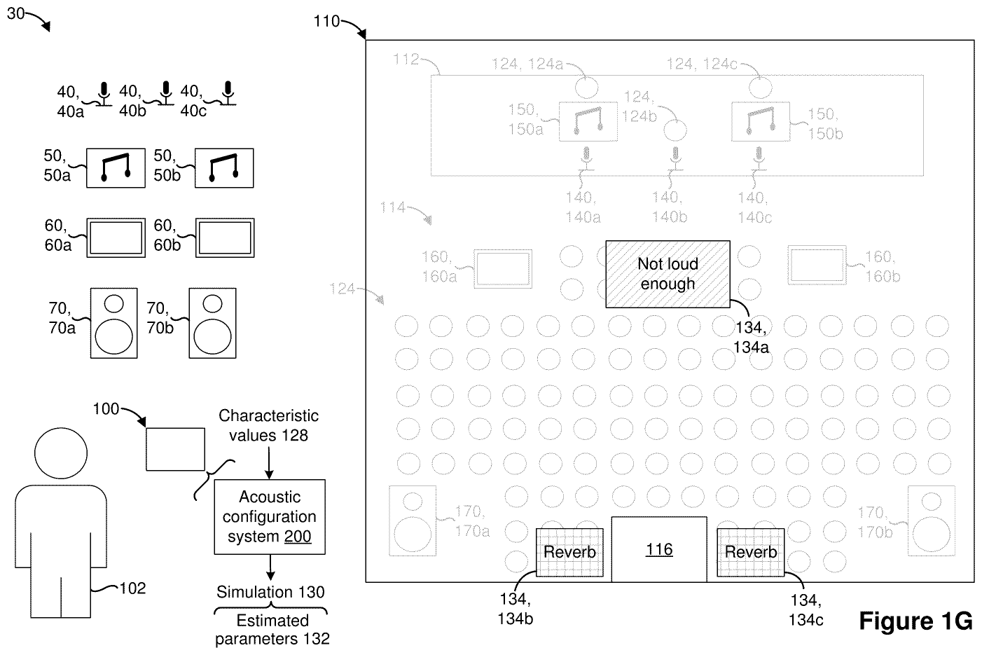

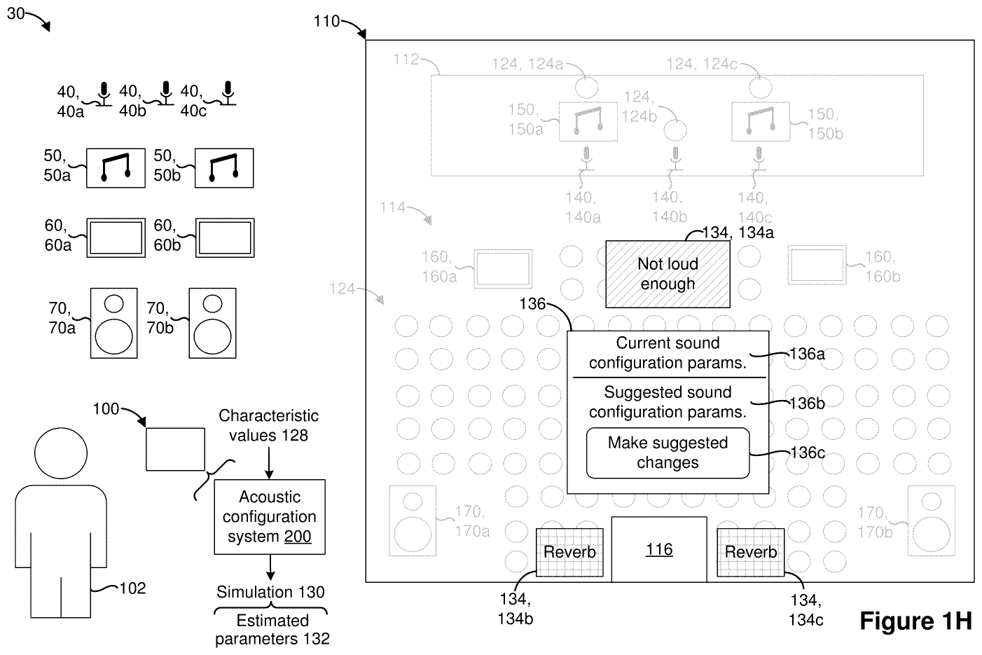

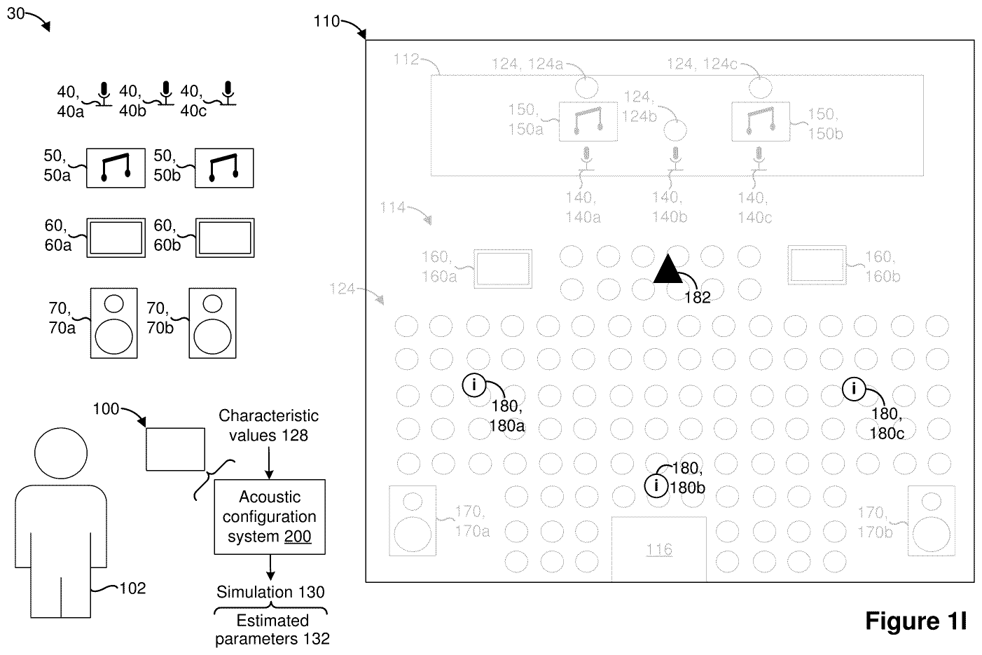

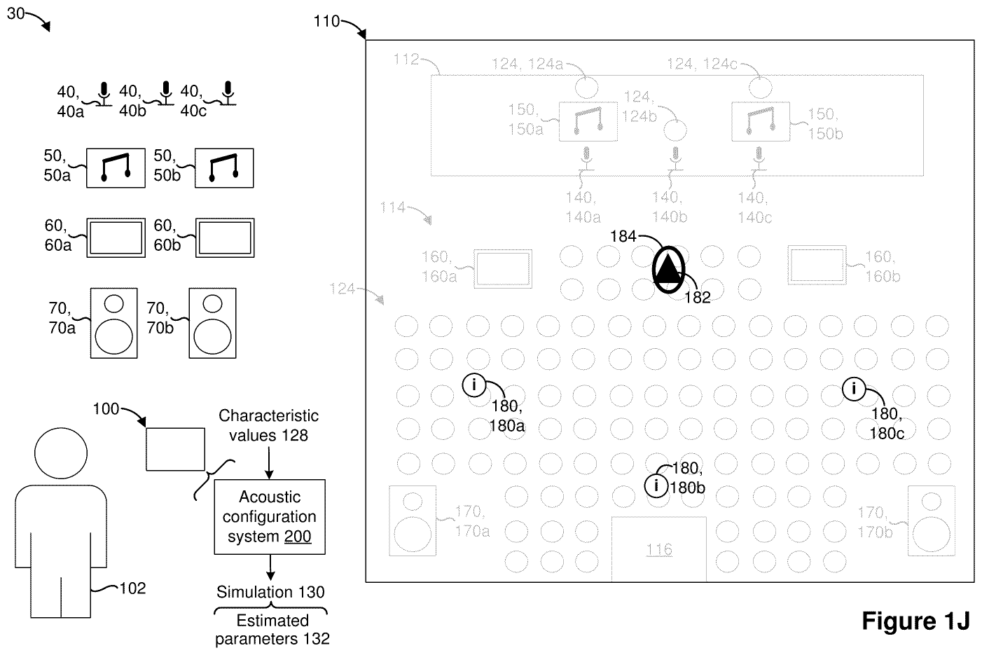

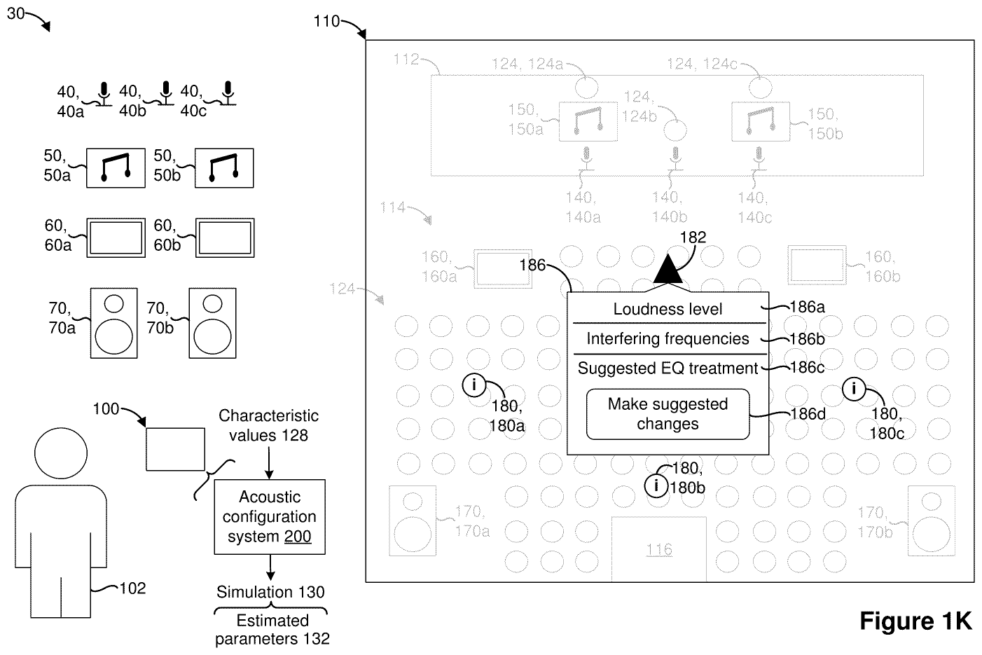

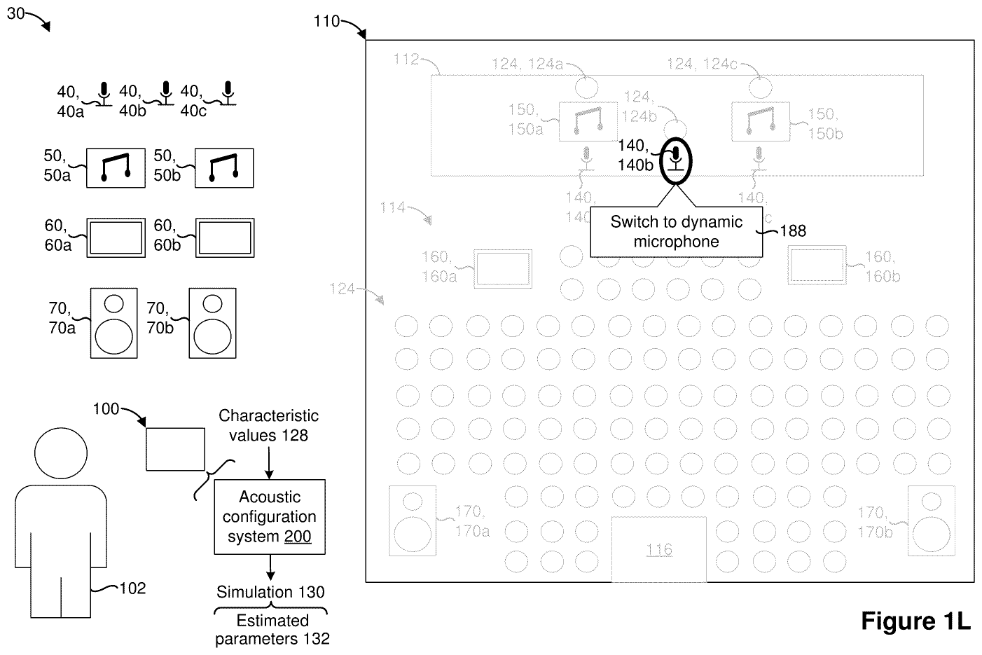

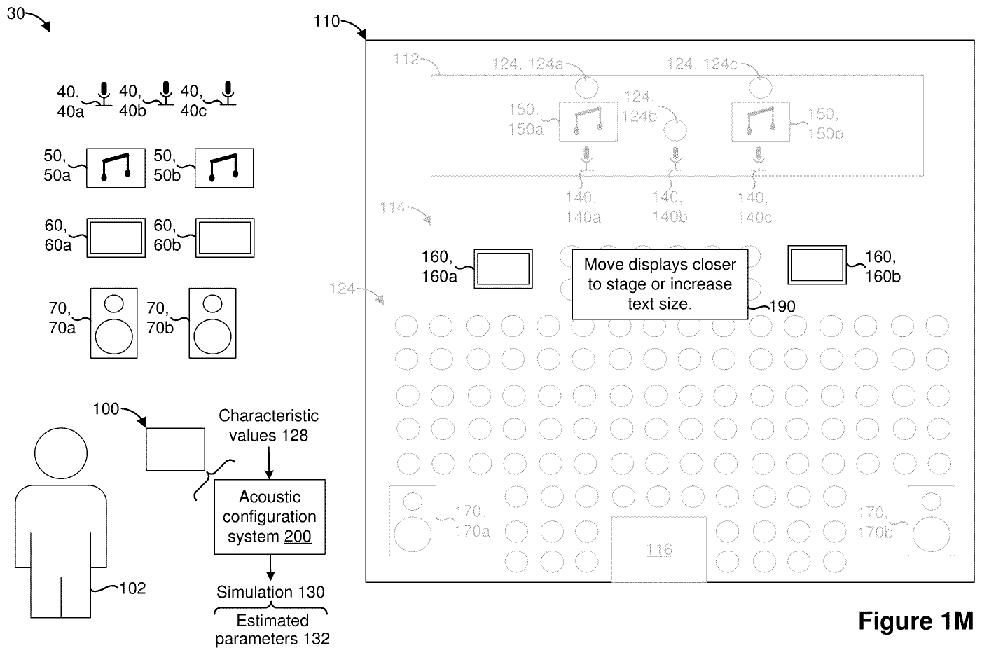

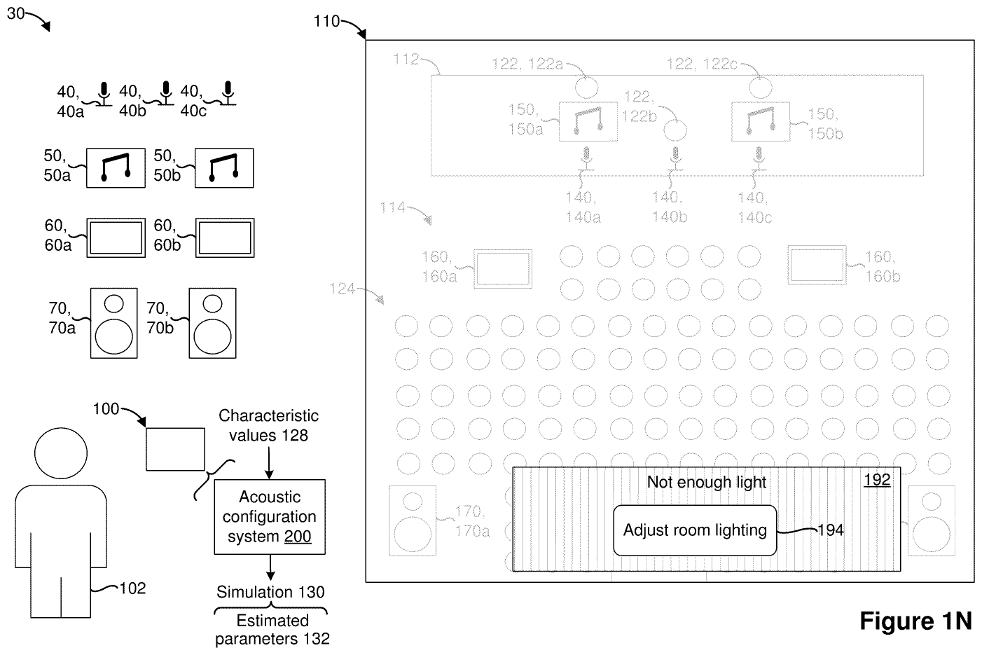

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the physical environment 10 includes a stage 12, an audience area 14 and a column 16 (e.g., a pillar). FIG. 1A further illustrates various acoustic instruments 30 that need to be placed within the physical environment 10 for a live performance (e.g., a concert or a show). The acoustic instruments 30 includes microphones 40 (e.g., a first microphone 40a, a second microphone 40b and a third microphone 40c), musical instruments 50 (e.g., a first musical instrument 50a and a second musical instrument 50b), displays 60 (e.g., a first display 60a and a second display 60b), and speakers 70 (e.g., a first speaker 70a and a second speaker 70b). In some implementations, the acoustic instruments 30 may include other types of acoustic instruments that are not illustrated in FIG. 1A (e.g., amplifiers). In various implementations, the musical instruments 50 include keyboard-based instruments such as a piano, string-based instruments such as a guitar or a cello, and/or mouth-based instruments (e.g., oral instruments such as a clarinet, a saxophone, etc.). In some implementations, the acoustic instruments 30 includes a mixing board that is used to set and/or adjust settings (e.g., configuration parameter values) for other acoustic instruments 30 (e.g., for setting and adjusting gain values of the microphones 40 and the speakers 70, for setting and adjusting the resolutions and text sizes of the displays 60, etc.).

FIG. 1A further illustrates an electronic device 100, a user 102 of the electronic device 100 and an acoustic configuration system 200. In various implementations, the user 102 configures the physical environment 10 for a live performance such as a concert, a show or a presentation. As such, the user 102 may be an audio engineer that has to determine placement locations for the acoustic instruments and various settings for the acoustic instruments (e.g., gain values, EQ settings, lighting parameters, etc.). In various implementations, the acoustic configuration system 200 provides a user interface that enables the user 102 to determine configuration parameters for the acoustic instruments 30 prior to placing the acoustic instruments 30 in the physical environment 10. In some implementations, the user interface allows the user 102 to overlay virtual representations of the acoustic instruments 30 onto a pass-through representation of the physical environment 10, and perform an acoustic simulation that generates estimated acoustic parameters that guide the user 102 in selecting configuration parameters for the acoustic instruments 30 without significant trial-and-error. In some implementations, the acoustic configuration system 200 resides at the electronic device 100. Alternatively, in some implementations, the acoustic configuration system 200 resides at another device (e.g., a remote device) that is in communication with the electronic device 100. In some implementations, a portion of the acoustic configuration system 200 resides at the electronic device 100 (e.g., a user-facing portion that presents the user interface) while a remainder of the acoustic configuration system 200 resides at the other device (e.g., a backend portion that performs the acoustic simulation and generates the estimated acoustic parameters).

In some implementations, the physical environment 10 represents an enclosed space such as a room, a banquet hall, a concert venue, a stadium, etc. Alternatively, in some implementations, the physical environment 10 represents an open space such as a park, an amphitheater, a backyard of a home, etc. In some implementations, the electronic device 100 includes a portable electronic device that the user 102 can carry throughout the physical environment 10 to assess local acoustic conditions at different portions of the physical environment 10. For example, as the user 102 carries the electronic device 100 within the physical environment 10, the acoustic configuration system 200 can display estimated acoustic parameters that are specific to a current location of the electronic device 100 within the physical environment 10. In some implementations, the electronic device 100 includes a smartphone, a tablet, a laptop or a desktop computer. In some implementations, the electronic device 100 includes a head-mountable device (HMD) that the user 102 wears around his/her head.

In some implementations, the electronic device 100 is in electronic communication with a mixing board that controls various configuration parameters for the acoustic instruments 30. In such implementations, the electronic device 100 can send a control signal to the mixing board and the mixing board can set and/or change the configuration parameters for the acoustic instruments 30 based on the control signal. As an example, the acoustic configuration system 200 may determine an EQ treatment and send an indication of the EQ treatment to the mixing board, and the mixing board applies the EQ treatment. In some implementations, the electronic device 100 implements the mixing board. For example, the electronic device 100 displays a graphical user interface that corresponds to (e.g., mimics) a mixing board.

Referring to FIG. 1B, the electronic device 100 displays an environment representation 110 of the physical environment 10. In some implementations, the environment representation 110 includes a pass-through of the physical environment 10 (e.g., an optical see-through or a video pass-through of the physical environment 10). In some implementations, the environment representation 110 includes a stage representation 112 that represents the stage 12 shown in FIG. 1A, an audience area representation 114 that represents the audience area 14 shown in FIG. 1A, and a column representation 116 that represents the column 16 shown in FIG. 1A. In some implementations, the electronic device 100 detects a user input 118 that corresponds to a request to overlay a virtual instrument that corresponds to one of the acoustic instruments 30 on top of the environment representation 110. In some implementations, the electronic device 100 displays the environment representation 110 on a touchscreen display, and the user input 118 includes a touch input on the touchscreen display.

Referring to FIG. 1C, in some implementations, the electronic device 100 displays a menu 120 in response to the user input 118 shown in FIG. 1B. The menu 120 includes various affordances (e.g., user-selectable options or buttons) that the user 102 can select to trigger display of respective virtual objects. In the example of FIG. 1C, the menu 120 includes a virtual mic affordance 120a, a virtual musical instrument affordance 120b, a virtual display affordance 120c, a virtual speaker affordance 120d and a virtual person affordance 120e. The virtual mic affordance 120a, when selected, causes the electronic device 100 to display virtual microphones that correspond to the microphones 40. The virtual musical instrument affordance 120b, when selected, causes the electronic device 100 to display virtual musical instruments that correspond to the musical instruments 50. The virtual display affordance 120c, when selected, causes the electronic device 100 to display virtual displays that correspond to the displays 60. The virtual speaker affordance 120d, when selected causes the electronic device 100 to display virtual speakers that corresponds to the speakers 60. The virtual person affordance 120e, when selected, causes the electronic device 100 to display virtual persons that simulate real persons (e.g., virtual presenters/performers/musicians and/or virtual audience members). In the example of FIG. 1C, the electronic device 100 detects a user input 122 directed to the virtual musical instrument affordance 120b.

Referring to FIG. 1D, in response to detecting the user input 122 shown in FIG. 1C, the electronic device 100 displays a virtual musical instrument 150. In particular, the virtual musical instrument 150 includes a first virtual musical instrument 150a that represents the first musical instrument 50a. The first virtual musical instrument 150a is of the same instrument type as the first musical instrument 50a. For example, if the first musical instrument 50a is an electric guitar then the first virtual musical instrument 150a is a virtual electric guitar that represents the electric guitar.

FIG. 1E illustrates the environment representation 110 with additional virtual instruments that correspond to the acoustic instruments 30. In the example of FIG. 1E, the environment representation 110 includes virtual microphones 140 that represent the microphones 40 (e.g., a first virtual microphone 140a that represents the first microphone 40a, a second virtual microphone 140b that represents the second microphone 40b and a third virtual microphone 140c that represents the third microphone 40c). The environment representation 110 includes virtual musical instruments 150 that represent the musical instruments 50 (e.g., the first virtual musical instrument 150a that represents the first musical instrument 50a and a second virtual musical instrument 150b that represents the second musical instrument 50b). The environment representation 110 includes virtual displays 160 that represent the displays 60 (e.g., a first virtual display 160a that represents the first display 60a and a second virtual display 160b that represents the second display 60b). The environment representation 110 includes virtual speakers 170 that represent the speakers 70 (e.g., a first virtual speaker 170a that represents the first speaker 70a and a second virtual speaker 170b that represents the second speaker 70b). In the example of FIG. 1E, the environment representation 110 includes virtual performers 124 that represent musicians (e.g., a first virtual performer 124a representing a first musician playing the first musical instrument 50a, a second virtual performer 124b representing a second musician using the second microphone 40b, and a third virtual performer 124c representing a third musician playing the second musical instrument 50b). The environment representation 110 further includes virtual audience members 126 that simulate real audience members. In some implementations, the virtual audience members 126 are programmed to make sounds similar to real audience members (e.g., clap, scream, sing along with the second musician, etc.).

As can be seen in FIG. 1E, the user interface presented by the electronic device 100 allows the user 102 to visualize placement of the acoustic instruments 30 without actually placing the acoustic instruments 30 through the physical environment 10. Since some of the acoustic instruments 30 may be heavy and/or delicate, reducing the need to move the acoustic instruments 30 in order to determine their placement locations within the physical environment 10 tends to expedite the process of setting up the acoustic instruments 30 in the physical environment 10. In some implementations, the user 102 places each of the virtual objects at their respective locations shown in FIG. 1E. Alternatively, in some implementations, the electronic device 100 (e.g., the acoustic configuration system 200) automatically determines placement of the virtual objects based on respective characteristics of their corresponding real objects.

Referring to FIG. 1F, in various implementations, the acoustic configuration system 200 obtains characteristic values 128 that characterize the acoustic instruments 30 and their corresponding virtual representations displayed within the environment representation 110. In some implementations, the characteristic values 128 indicate respective target positions (e.g., respective desired placement locations) for the acoustic instruments 30. For example, the user 102 may specify where the user 102 wants to place each of the acoustic instruments 30. In some implementations, the characteristic values 128 indicate respective instrument types of the acoustic instruments 30. For example, the characteristic values 128 may indicate that the second microphone 40b is a dynamic microphone, the first musical instrument 50a is an electric guitar, and the speakers 70 are 3-way speakers for a particular size. In some implementations, the characteristic values 128 indicate respective functionalities of the acoustic instruments 30. For example, the characteristic values 128 may indicate respective pickup patterns or respective pickup sensitivities for the microphones 40. As another example, the characteristic values 128 may indicate respective gain values, bass values or treble values for the speakers 70. As yet another example, the characteristic values 128 may indicate respective brightness values, respective resolutions or respective text sizes for the displays 60.

In some implementations, the characteristic values 128 characterize ambient lighting of the physical environment 10. For example, the characteristic values 128 may indicate an intensity and/or a color of the ambient lighting. In some implementations, the characteristic values 128 indicate materials of the physical environment 10. For example, the characteristic values 128 may indicate sound reflectiveness or absorptiveness of various materials in the physical environment 10.

In various implementations, the acoustic configuration system 200 generates an acoustic simulation 130 based on the characteristic values 128. The acoustic simulation 130 outputs estimated acoustic parameters 132 for various locations within the physical environment 10. In various implementations, the estimated acoustic parameters 132 indicate how audible signals generated by various entities in the physical environment 10 may sound at various locations through the physical environment 10. The estimated acoustic parameters 132 provide an indication of how music produced by musicians represented by the virtual performers 124 will sound at various locations within the physical environment 10 when the acoustic instruments 30 are placed and configured in a manner similar to the corresponding virtual representations of the acoustic instruments 30.

In some implementations, the estimated acoustic parameters 132 include estimated sound intensity values for various locations within the physical environment 10. For example, the estimated acoustic parameters 132 may include estimated sound amplitude values for various locations within the physical environment 10. In some implementations, the estimated acoustic parameters 132 may indicate estimated echo levels and/or estimated reverberation levels at various different locations within the physical environment 10.

In various implementations, in addition to setting up the acoustic instruments 30, the user 102 is responsible for setting up lighting instruments such as focus lights, strobe lights, stage lights, etc. In such implementations, the electronic device 100 allows the user 102 to place virtual light instruments that represent the lighting instruments throughout the environment representation 110. Furthermore, in addition to performing the acoustic simulation 130, the electronic device 100 performs a lighting simulation that generates estimated lighting parameters. The estimated lighting parameters indicate estimated lighting levels at various locations within the physical environment 10. For example, the estimated lighting levels may indicate estimate light intensities and/or estimated light colors at various different locations within the physical environment 10. The user 102 can utilize the estimated lighting levels to adjust configuration settings for the lighting instruments. For example, the user 102 can utilize the estimated lighting levels to determine placement positions and/or light intensities for the lighting instruments. In some implementations, the acoustic configuration system 200 performs the lighting simulation in addition to performing the acoustic simulation 130. As such, the acoustic configuration system 200 may generate the estimated lighting parameters in addition to the estimated acoustic parameters 132. In some implementations, the lighting simulation is a part of the acoustic simulation 130. As such, the estimated acoustic parameters 132 may include the estimated lighting parameters.

In various implementations, the virtual representations of the acoustic instruments 30 have the same or similar configuration settings as the acoustic instruments 30. For example, the virtual microphones 140 have the same or similar pickup patterns and gain settings as the corresponding microphones 40. In this example, the user 102 can adjust the gain settings of the virtual microphones 140 based on the estimated acoustic parameters 132. For example, if the estimated acoustic parameters 132 indicate that the first virtual microphone 140a is not sufficiently picking up the sound generated by the first virtual musical instrument 150a, the user 102 can increase the gain value of the first virtual microphone 140a and use the increased gain value for the first microphone 40a. As such, when the user 102 setups the first microphone 40a in the physical environment 10, the first microphone 40a will be configured with a suitable gain value that allows the first microphone 40a to appropriately capture sounds generated by the first musical instrument 50a. More generally, in various implementations, the user 102 can utilize the estimated acoustic parameters 132 to adjust configuration settings for the virtual acoustic instruments and utilize the adjusted configuration settings for the acoustic instruments 30 instead of determining configuration settings for the acoustic instruments 30 using trial-and-error.

Referring to FIG. 1G, in various implementations, the acoustic configuration system 200 presents indications 134 of the estimated acoustic parameters 132. In the example of FIG. 1G, the indications 134 include a loudness indication 134a, and reverberation indications 134b and 134c. The loudness indication 134a indicates that, according to the estimated acoustic parameters 132, sound levels in a portion of the physical environment 10 covered by the loudness indication 134a are below a threshold sound level. In the example of FIG. 1G, the loudness indication 134a is relatively far away from the virtual speakers 170. As such, in order to increase the sound levels in the portion of the physical environment 10 that is covered by the loudness indication 134a, the volume setting of the virtual speakers 170 may need to be increased. The electronic device 100 may display the loudness indication 134a by coloring that portion of the environment representation 110 (e.g., by overlaying a red mask on top of that portion of the environment representation 110).

The reverberation indications 134b and 134c indicate presence of reverberations on a left side and a right side of the column representation 116. The reverberation indications 134b and 134c are displayed when the estimated acoustic parameters 132 indicate that estimated levels of reverberation exceed an acceptable level of reverberation. The user 102 can adjust the configuration settings of the virtual acoustic instruments to reduce the reverberations on both sides of the column representation 116, for example, by performing an EQ treatment such as causing the virtual speakers 170 to output audible signals that cancel the reverberations. The electronic device 100 may display the reverberation indications 134b and 134c by coloring those portions of the environment representation 110 (e.g., by overlaying yellow masks on top of those portions of the environment representation 110).

Referring to FIG. 1H, in various implementations, the acoustic configuration system 200 suggests changes to configuration settings of the virtual acoustic instruments in order to address estimated acoustic parameters 132 that are outside of acceptable ranges. In the example of FIG. 1H, the electronic device 100 displays a menu 136 that includes current sound configuration parameters 136a, suggested sound configuration parameters 136b and a make suggested changes affordance 136c for changing the current sound configuration parameters 136a to the suggested sound configuration parameters 136b. In some implementations, the current sound configuration parameters 136a include current gain values for the virtual microphones 140, current tuning parameters for the virtual musical instruments 150 (e.g., current string tightness for string-based musical instruments), current display settings for the virtual displays 160 (e.g., current resolution, text size, etc.), current speaker settings for the virtual speakers 170 (e.g., current volume level, bass, treble, etc.) and/or current light settings for virtual lighting instruments (e.g., current brightness, color, pattern, frequency, etc.). In some implementations, the suggested sound configuration parameters 136b include suggested gain values for the virtual microphones 140, suggested tuning parameters for the virtual musical instruments 150 (e.g., suggested string tightness for string-based musical instruments), suggested display settings for the virtual displays 160 (e.g., suggested resolution, text size, etc.), suggested speaker settings for the virtual speakers 170 (e.g., suggested volume level, bass, treble, etc.) and/or suggested light settings for virtual lighting instruments (e.g., suggested brightness, color, pattern, frequency, etc.).

In some implementations, a user input directed to the make suggested changes affordance 136c causes the electronic device 100 to change the current sound configuration parameters 136a to the suggested sound configuration parameters 136b. For example, selecting the make suggested changes affordance 136c triggers a change from the current gain values to the suggested gain values for the virtual microphones 140, a change from the current tuning parameters to the suggested tuning parameters for the virtual musical instruments 150, a change from the current display settings to the suggested displays settings for the virtual displays 160, a change from the current speaker settings to the suggested speaker settings for the virtual speakers 170, and/or a change from the current light settings to the suggested light settings for the virtual lights. In some implementations, changing the current sound configuration parameters 136a to the suggested sound configuration parameters 136b includes moving some of the virtual instruments from a current location to a suggested location.

FIG. 1I illustrates information indicators 180 that are overlaid onto various portions of the environment representation 110. For example, a first information indicator 180a is overlaid towards a left portion of the environment representation 110, a second information indicator 180b is overlaid towards a right portion of the environment representation 110 and a third information indicator 180c is overlaid towards a bottom portion of the environment representation 110. When the electronic device 100 detects a user input directed to one of the information indicators 180, the electronic device 100 displays the estimated acoustic parameters 132 that are related to a corresponding portion of the physical environment 10. For example, when the electronic device 100 detects a user input directed to the first information indicator 180a, the electronic device 100 displays a portion of the estimated acoustic parameters 132 that are relevant to the left portion of the physical environment 10.

FIG. 1I further illustrates a warning indicator 182 that is overlaid onto a front portion of the environment representation 110. The warning indicator 182 indicates that at least some of the estimated acoustic parameters 132 that correspond to a front portion of the physical environment 10 are outside an acceptable range. When the electronic device 100 detects a user input directed to the warning indicator 182, the electronic device 100 can display which of the estimated acoustic parameters 132 is outside the acceptable range and to what extent. For example, the electronic device 100 may display the loudness indication 134a shown in FIG. 1G in response to detecting a user input directed to the warning indicator 182.

FIG. 1J illustrates a user input 184 directed to the warning indicator 182. As shown in FIG. 1K, the electronic device 100 displays a menu 186 in response in detecting the user input 184 shown in FIG. 1J. The menu 186 displays an estimate of a loudness level 186a in the front portion of the physical environment 10, interfering frequencies 186b, a suggested EQ treatment 186c and a make changes affordance 186d. In some implementations, the estimated acoustic parameters 132 indicate expected frequency interference in the front portion of the physical environment 10. The suggested EQ treatment 186c may include applying a filter (e.g., a low pass filter, a high pass filter, a band pass filter) in order to reduce an impact of the interfering frequencies. When the electronic device 100 detects a user input selecting the make changes affordance 186d, the electronic device 100 applies the suggested EQ treatment 186c in order to reduce an impact of the interfering frequencies. In some implementations, the electronic device 100 triggers (e.g., instructs) a mixing board to apply the suggested EQ treatment 186c.

Referring to FIG. 1L, in some implementations, the acoustic configuration system 200 provides recommendations to replace some of the virtual instruments in order to improve the estimated acoustic parameters 132. In the example of FIG. 1L, the acoustic configuration system 200 displays a mic suggestion 188 to replace the second virtual microphone 140b with a dynamic microphone, for example, to better capture sounds generated by the second virtual performer 124b. In some implementations, replacing some of the virtual instruments with the replacements suggested by the acoustic configuration system 200 results in revised estimated acoustic parameters 132 that are within acceptable ranges.

Referring to FIG. 1M, in some implementations, the acoustic configuration system 200 provides recommendations to move some of the virtual instruments to different locations within the environment representation 110 in order to improve the estimated acoustic parameters 132. In the example of FIG. 1M, the acoustic configuration system 200 displays a display suggestion 190 to move the virtual displays 160 closer to the stage or to increase a text size of text displayed on the virtual displays 160, for example, so that the virtual performers 124 can better view the text (e.g., song lyrics or presentation points) displayed on the virtual displays 160. In some examples, the acoustic configuration system 200 may recommend moving the virtual microphones 140 to different locations within the environment representation 110 in order to better capture the sounds generated by the virtual performers 124. In other examples, the acoustic configuration system 200 may recommend moving the virtual speakers to different locations within the environment representation 110 so that the sound emitted by the corresponding speakers 70 sufficiently propagates throughout the physical environment 10.

Referring to FIG. 1N, in some implementations, the electronic device 100 (e.g., the acoustic configuration system 200 or a lighting configuration system) recommends changes to lighting instruments. In the example of FIG. 1N, the electronic device 100 displays a low light indication 192 to indicate that a portion of the physical environment 10 encompassed by the low light indication 192 is not sufficiently lit. The low light indication 192 includes a light adjustment affordance 194. When the electronic device 100 detects a user input directed to the light adjustment affordance 194, the electronic device 100 adjusts configuration settings of virtual lighting instruments. For example, the electronic device 10 increases an intensity of virtual lights that provide light to the portion of the environment representation 110 encompassed by the low light indication 192.

In various implementations, the acoustic configuration system 200 displays indications of the estimated acoustic parameters 132 in order to guide the user 102 in adjusting configuration settings for various virtual instruments. After the user 102 has finished adjusting the configuration settings for the virtual instruments, the acoustic configuration system 200 can generate a report that includes all the configuration settings that the user 102 selected based on the estimated acoustic parameters 132. The user 102 can utilize the report to configure the acoustic instruments 30 in the physical environment 10 thereby reducing the need for using trail-and-error to determine the settings for the acoustic instruments 30. As an example, the report may include placement locations for various virtual instruments and the user 102 can place corresponding physical instruments at the same placement locations thereby reducing the need for using trial-and-error to determine placement locations for the physical instruments. As another example, the report may include EQ treatment that results in the least amount of echoes and reverberations, and the user 102 can apply the same EQ treatment without resorting to trial-and-error after the physical instruments have been placed in the physical environment 10.

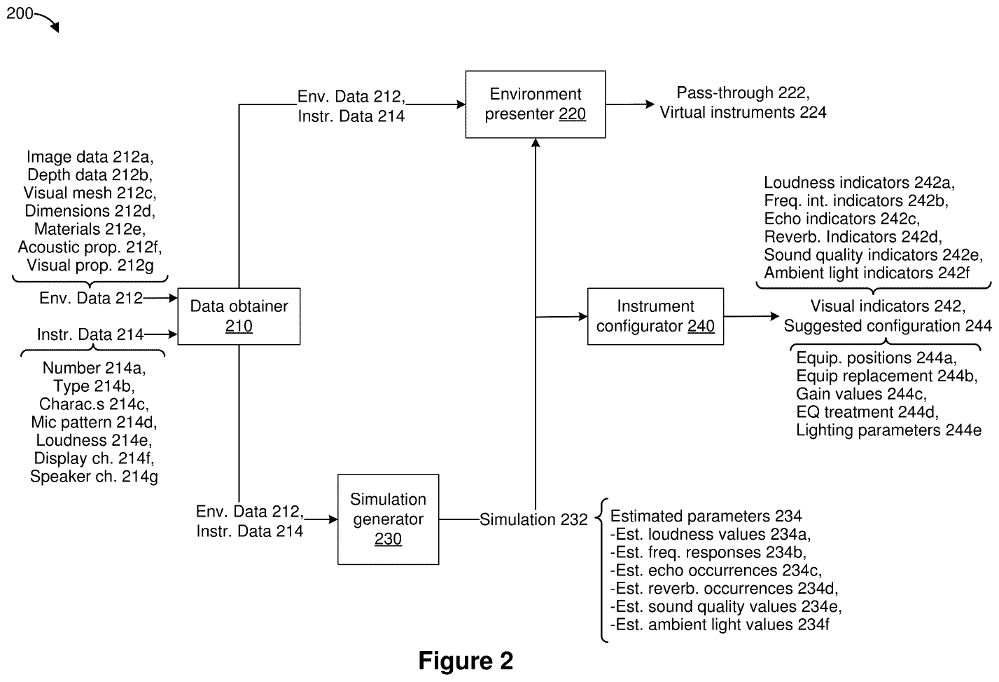

FIG. 2 is a block diagram of the acoustic configuration system 200 in accordance with some implementations. In various implementations, the acoustic configuration system 200 includes a data obtainer 210, an environment presenter 220, a simulation generator 230 and an instrument configurator 240.

In various implementations, the data obtainer 210 obtains environmental data 212 corresponding to a physical environment (e.g., the physical environment 10 shown in FIG. 1A). In some implementations, the environmental data 212 includes image data 212a. In some implementations, the image data 212a includes images of the physical environment and the instruments that are to be placed in the physical environment (e.g., images of the physical environment 10 and the acoustic instruments 30 shown in FIG. 1A). In some implementations, the environmental data 212 includes depth data 212b. For example, the electronic device 100 (shown in FIG. 1A) may include a depth camera that captures the depth data 212b of the physical environment 10. In some implementations, the environmental data 212 includes a visual mesh 212c of the physical environment. In some implementations, the data obtainer 210 utilizes the image data 212a and/or the depth data 212b to generate the visual mesh 212c. In some implementations, the environmental data 212 indicates environment dimensions 212d (e.g., physical dimensions of the physical environment 10 shown in FIG. 1A). In some implementations, the data obtainer 210 determines the environment dimensions 212d based on the image data 212a, the depth data 212b or the visual mesh 212c. In some implementations, the environmental data 212 indicates materials 212e that are found in the physical environment, acoustic properties 212f of the materials 212e and/or visual properties 212g of the materials 212e. For example, the environmental data 212 may indicate whether the materials 212e in the physical environment reflect sound/light and to what extent. In some implementations, the data obtainer 210 identifies the materials 212e based on the image data 212a and retrieves the acoustic properties 212f and the visual properties 212g of the materials 212e from a datastore that stores properties of various materials.

In some implementations, the data obtainer 210 obtains instrument data 214 that characterizes various instruments that are to be placed in a physical environment. For example, the instrument data 214 includes the characteristic values 128 shown in FIGS. 1F-1N. In some implementations, the instrument data 214 indicates a number of instruments 214a that are to be placed within the physical environment (e.g., a number of microphones, speakers, displays, musical instruments and/or lighting instruments). In some implementations, the instrument data 214 indicates instrument types 214b of the instruments that are to be placed in the physical environment. As an example, the instrument types 214b may indicate types of microphones, sizes of displays, sizes of speakers, types of musical instruments (e.g., acoustic, electric, string-based, keyboard-based, etc.) and types of lighting instruments (e.g., flood lights, focus lights, LED lights, ambient lights, stage lights, etc.) that are to be placed in the physical environment. In some implementations, the instrument data 214 indicates instrument characteristics 214c of the instruments that are to be placed in the physical environment. As an example, the instrument characteristics 214c indicate resolutions of the displays, power values of the speakers and/or intensities/colors of light emitted by the lighting instruments. In some implementations, the instrument data 214 includes microphone pickup patterns 214d of the microphones (e.g., cardioid, hypercardioid, figure of eight, omnidirectional, shotgun, etc.). In some implementations, the instrument data 214 indicates musical instrument loudness 214e of the musical instruments. In some implementations, the instrument data 214 indicates display characteristics 214f of the displays (e.g., sizes and resolutions). In some implementations, the instrument data 214 indicates speaker characteristics 214g of the speakers (e.g., size, rated power, class of loudspeaker, frequency response, etc.). In some implementations, the data obtainer 210 determines the instrument data 214 based on the environmental data 212. For example, the data obtainer 210 utilizes the image data 212a to identify a make and model of the instruments, and retrieves various characteristics of the instruments from a datastore that stores information regarding instruments.

In some implementations, the environment presenter 220 presents a pass-through 222 of the physical environment. For example, the environment presenter 220 presents the environment representation 110 shown in FIGS. 1B-1N. In some implementations, the pass-through 222 is an optical see-through of the physical environment and the environment presenter 220 presents the optical see-through by allowing light from the physical environment to pass-through an optical see-through display and enter eyes of the user. In some implementations, the pass-through 222 is a video pass-through of the physical environment and the environment presenter 220 presents the video pass-through by capturing image data with a camera of the electronic device and displaying the captured image data on an opaque display.

In various implementations, the environment presenter 220 overlays virtual instruments 224 on top of the pass-through 222. In some implementations, the virtual instruments 224 includes virtual microphones, virtual musical instruments, virtual displays, virtual speakers and/or virtual lighting instruments. For example, the environment presenter 220 overlays the virtual microphones 140, the virtual musical instruments 150, the virtual displays 160 and the virtual speakers 170 shown in FIG. 1E. In some implementations, the environment presenter 220 overlays the virtual instruments 224 based on user inputs requesting placement of the virtual instruments 224 (e.g., in response to receiving the user input 122 shown in FIG. 1C). Alternatively, in some implementations, the environment presenter 220 automatically overlays the virtual instruments 224. For example, the environment presenter 220 automatically determines placement locations of the virtual instruments 224 based on the environmental data 212 and the instrument data 214. In some implementations, the environment presenter 220 overlays virtual people (e.g., the virtual performers 124 and the virtual audience members 126 shown in FIG. 1E).

In various implementations, the simulation generator 230 generates a simulation 232 after the environment presenter 220 overlays the virtual instruments 224 onto the pass-through 222. For example, the simulation generator 230 generates the acoustic simulation 130 shown in FIGS. 1F-1N. In various implementations, the simulation 232 results in estimated parameters 234 (e.g., the estimated acoustic parameters 132 shown in FIGS. 1F-1N) that provide an indication of how the physical environment may sound or look when physical instruments are configured (e.g., placed and setup) in a manner similar to the corresponding virtual instruments 224.

In some implementations, the estimated parameters 234 include estimated loudness values 234a for various locations within the physical environment. The estimated loudness values 234a indicate how loud various locations within the physical environment may sound when physical instruments are configured in a manner similar to the virtual instruments 224. As an example, referring to FIG. 1G, the estimated loudness values 234a may indicate that a portion of the physical environment in front of the stage 12 may not be loud enough when the speakers 70 are placed at the locations indicated by the virtual speakers 170 and the speakers 70 are configured in a manner similar to the virtual speakers 170 (e.g., with the same settings). In some implementations, the estimated loudness values 234a include sound duration values (e.g., how long a sound lingers), sound frequencies (e.g., pitches) and sound intensity values (e.g., in decibels).

In some implementations, the estimated parameters 234 include estimated frequency responses 234b for various locations within the physical environment. The frequency responses 234b may indicate locations within the physical environment with undesirable frequencies (e.g., an unacceptable level of frequency interference). In some implementations, the estimated parameters 234 include estimated echo occurrences 234c that indicate areas within the physical environment where an amount of echoes is expected to be greater than a threshold amount of echoes. In some implementations, the estimated parameters 234 includes estimated reverberation occurrences 234d that indicate areas within the physical environment where a level of reverberation is expected to be greater than a threshold level of reverberation. For example, as shown in FIG. 1G, the acoustic configuration system 200 displays the reverberation indications 134b and 134c. In some implementations, the estimated parameters 234 include estimated sound quality values 234e for various locations within the physical environment. As an example, referring to FIG. 1I, the user 102 can tap the information indicators 180 or the warning indicator 182 to view the estimated sound quality values 234e. In some implementations, the estimated parameters 234 include estimated ambient light values 234f for various locations within the physical environment. The estimated ambient light values 234f indicate how bright various areas within the physical environment are expected to be when physical lighting instruments are placed at the locations indicated by virtual lighting instruments and the physical lighting instruments are configured with the same settings as the virtual lighting instruments (e.g., same brightness levels and colors). For example, as shown in FIG. 1N, the electronic device 100 displays the low light indication 192.

In various implementations, the simulation generator 230 provides the estimated parameters 234 to the environment presenter 220 and/or the instrument configurator 240. In some implementations, the instrument configurator 240 displays visual indicators 242 based on the estimated parameters 234. In some implementations, the visual indicators 242 include loudness indicators 242a that are based on the estimated loudness values 234a (e.g., the loudness indication 134a shown in FIG. 1G). In some implementations, the visual indicators 242 includes frequency interference indicators 242b that are based on the estimated frequency responses 234b (e.g., the indication of interfering frequencies 186b shown in FIG. 1K). In some implementations, the visual indicators 242 includes echo indicators 242c that are based on the estimated echo occurrences 234c. In some implementations, the visual indicators 242 include reverberation indicators 242d that are based on the estimated reverberation occurrences 234d (e.g., the reverberation indications 134b and 134c shown in FIG. 1G). In some implementations, the visual indicators 242 include sound quality indicators 242e that are based on the estimated sound quality values 234e (e.g., the warning indicator 182 shown in FIG. 1I). In some implementations, the visual indicators 242 include ambient light indicators 242f that are based on the estimated ambient light values 234f (e.g., the low light indication 192 shown in FIG. 1N).

In some implementations, the instrument configurator 240 determines a suggested configuration 244 for some of instruments based on the estimated parameters 234 being outside an acceptability range. In some implementations, the suggested configuration 244 includes suggested equipment positions 244a. For example, as shown in FIG. 1M, the electronic device 100 displays the display suggestion 190 to move the virtual displays 160 closer to the stage. In some implementations, moving equipment in accordance with the suggested equipment positions 244a tends to result in revised estimated parameters that are within the acceptability range. For example, moving some of the instruments may result in revised estimated loudness values that are within an acceptable loudness range.

In some implementations, the suggested configuration 244 includes a suggested equipment replacement 244b. For example, as shown in FIG. 1L, the electronic device 100 displays the mic suggestion 188 to replace the second virtual microphone 140b with a dynamic microphone in order to better capture the voice of the second virtual performer 124b. In some implementations, replacing current equipment with the suggested equipment results in revised estimated parameters that are within the acceptability range. For example, switching to the dynamic microphone may result in revised estimated frequency responses that are within an acceptable frequency response range.

In some implementations, the suggested configuration 244 includes suggested gain values 244c for the microphones and/or the speakers. In some implementations, changing current gain values to the suggested gain values 244c tends to result in revised estimated parameters that are within acceptable ranges. For example, switching to the suggested gain values 244c may result in revised estimated echo occurrences that are below a threshold number of echo occurrences. In some implementations, the instrument configurator 240 displays an affordance that, when selected, triggers a mixing board to change current gain values to the suggested gain values 244c. For example, as shown in FIG. 1H, a user selection of the makes suggested changes affordance 136c triggers the electronic device 100 to change the current sound configuration parameters 136a to the suggested sound configuration parameters 136b.

In some implementations, the suggested configuration 244 includes a suggested EQ treatment 244d. In some implementations, applying the suggested EQ treatment 244d results in revised estimated parameters that are within acceptable ranges. For example, applying the suggested EQ treatment 244d may result in revised estimated sound quality values that are within an acceptable sound quality range. In some implementations, the instrument configurator 240 displays an affordance that, when selected, triggers a mixing board to apply the suggested EQ treatment 244d. For example, as shown in FIG. 1K, a user selection of the makes changes affordance 186d triggers the electronic device 100 to apply the suggested EQ treatment 186c in order to reduce an impact of the interfering frequencies 186b.

In some implementations, the suggested configuration 244 includes suggested lighting parameters 244e. The suggested lighting parameters 244e may include suggested intensities, suggested light color emission settings and/or suggested frequencies for the lighting instruments. In some implementations, changing current lighting parameters to the suggested lighting parameters 244e results in revised estimated ambient light values that are within acceptable ambient lighting ranges. In some implementations, the instrument configurator 240 displays an affordance that, when selected, triggers a change from current lighting parameters to the suggested lighting parameters 244e. For example, as shown in FIG. 1N, a user selection of the light adjustment affordance 194 triggers the electronic device 100 to adjust lighting so that the back area of the physical environment 10 is sufficiently lit.

In various implementations, the instrument configurator 240 provides the suggested configuration 244 to environment presenter 220 and the environment presenter 220 displays the suggested configuration 244 as an overlay on the pass-through 222 (e.g., the menu 136 shown in FIG. 1H or the menu 186 shown in FIG. 1K). In some implementations, the instrument configurator 240 causes the environment presenter 220 to display a user-selectable affordance that, when selected, triggers the electronic device 100 (shown in FIGS. 1A-1N) or a mixing board to change a current configuration to the suggested configuration 244 (e.g., the make suggested changes affordance 136c shown in FIG. 1H or the make suggested changes affordance 186d shown in FIG. 1K). In some implementations, the instrument configurator 240 provides the suggested configuration 244 to a mixing board by causing a change in an appearance of some of the physical controls of the mixing board (e.g., by flashing a knob for gain when the suggested configuration 244 requires an adjustment to the gain).

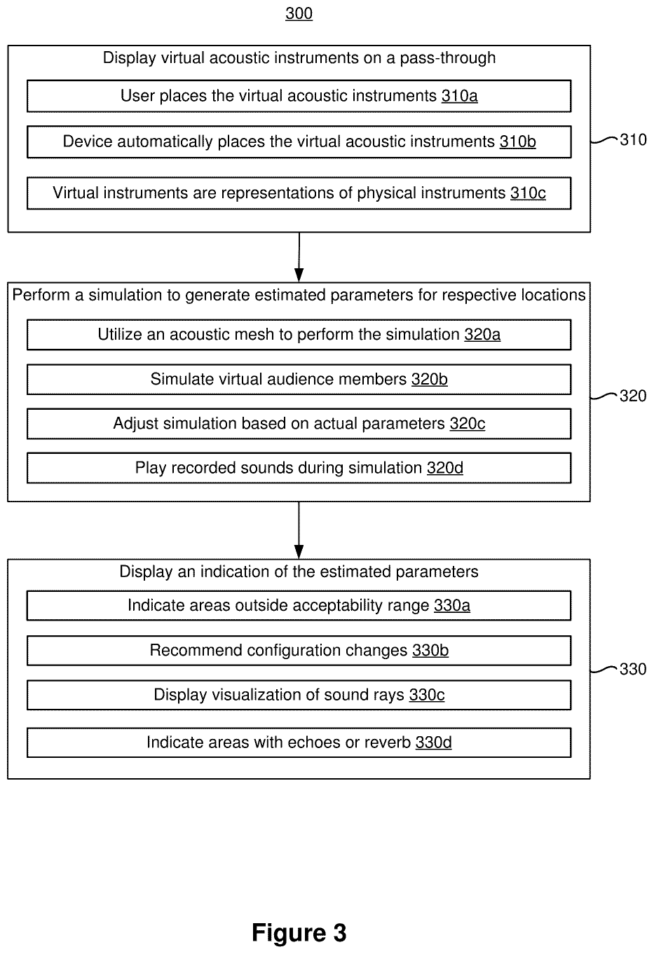

FIG. 3 is a flowchart representation of a method 300 for configuring physical instruments based on a simulation of corresponding virtual instruments. In various implementations, the method 300 is performed by the electronic device 100 shown in FIGS. 1A-IN and/or the acoustic configuration system 200 shown in FIGS. 1A-2. In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes displaying, on the display, virtual acoustic instruments as being overlaid onto a pass-through of a physical environment. For example, as shown in FIG. 1E, the electronic device 100 overlays the virtual instruments 140, 150, 160 and 170 onto the environment representation 110. As represented by block 310a, in some implementations, displaying the virtual acoustic instruments includes receiving a user input that indicates respective placement locations for the virtual acoustic instruments. For example, as shown in FIG. 1C, the electronic device 100 detects the user input 122 that corresponds to a request to place a virtual musical instrument on the stage representation 112. As represented by block 310b, in some implementations, displaying the virtual acoustic instruments includes automatically placing the virtual acoustic instruments based on dimensions of the physical environment. For example, as discussed in relation to FIG. 1E, in some implementations, the electronic device 100 automatically determines placement locations for the virtual instruments 140, 150, 160 and 170, the virtual performers 124 and the virtual audience members 126 based on a layout of the physical environment 10. As represented by block 310c, in some implementations, the virtual acoustic instruments represent physical acoustic instruments. For example, as shown in FIG. 1E, the virtual microphones 140 represent the microphones 40, the virtual musical instruments 150 represent the musical instruments 50, the virtual displays 160 represent the displays 60 and the virtual speakers 170 represent the speakers 70.

As represented by block 320, in various implementations, the method 300 includes performing, based on respective characteristics of the virtual acoustic instruments, an acoustic simulation in order to generate estimated acoustic parameters for respective locations within the physical environment. For example, as shown in FIG. 1F, the acoustic configuration system 200 performs the acoustic simulation 130 based on the characteristic values 128 in order to generate the estimated acoustic parameters 132. As another example, as shown in FIG. 2, the simulation generator 230 utilizes the environmental data 212 and/or the instrument data 214 to perform the simulation 232 resulting in the estimated parameters 234. In various implementations, performing the acoustic simulation allows a user of the electronic device (e.g., an audio engineer) to assess a planned configuration (e.g., planned placements and planned settings) of various physical instruments before placing the physical instruments in the physical environment.

As represented by block 320a, in some implementations, performing the acoustic simulation includes obtaining an acoustic mesh for the physical environment and performing the acoustic simulation based on the acoustic mesh. In some implementations, the electronic device generates the acoustic mesh by modifying a visual mesh based on acoustical properties of materials in the physical environment. The acoustic mesh indicates acoustical properties of materials in the physical environment. For example, the acoustic mesh indicates sound absorption levels and sound reflection levels of various portions of the physical environment.

As represented by block 320b, in some implementations, the method 300 includes displaying virtual audience members that are overlaid onto the pass-through of the physical environment. For example, as shown in FIG. 1E, the electronic device 100 displays the virtual audience members 126. In some implementations, performing the acoustic simulation includes simulating sound being absorbed by or reflected off the virtual audience members. For example, referring to FIG. 1F, the virtual audience members 126 can absorb and reflect sound generated by the musical instruments to varying degrees. In some implementations, performing the acoustic simulation includes simulating the virtual audience members making sound. For example, referring to FIG. 1F, the virtual audience members 126 are programmed to talk, scream and/or sing along with the virtual performers 124.

As represented by block 320c, in some implementations, the method 300 includes measuring actual acoustic parameters when physical acoustic instruments are placed at locations corresponding to the virtual acoustic instruments, and adjusting the acoustic simulation based on a difference between the actual acoustic parameters and the estimated acoustic parameters. As an example, referring to FIG. 1F, the electronic device 100 measures actual acoustic parameters when the acoustic instruments 30 are placed at locations indicated by the virtual instruments and the electronic device 100 utilizes differences in the actual acoustic parameters and the estimated acoustic parameters 132 to update the acoustic simulation 130 (e.g., to correct/compensate for differences between the virtual instruments and the physical instruments)

As represented by block 320d, in some implementations, performing the acoustic simulation includes playing prerecorded sounds of musical instruments. In some implementations, the electronic device measures (e.g., estimates) acoustic parameters at various locations within the environment after playing the prerecorded sounds to assess how the prerecorded sounds sound at the various locations within the environment. For example, referring to FIG. 1F, the electronic device 100 may determine the estimated acoustic parameters 132 by estimating detection of audible signals at various locations after playing the prerecorded sounds of musical instruments.

As represented by block 330, in various implementations, the method 300 includes displaying, on the display, an indication of the estimated acoustic parameters. For example, as shown in FIG. 1G, the electronic device 100 displays the indications 134 based on the estimated acoustic parameters 132. In various implementations, displaying the indication of the estimated acoustic parameters reduces the need to actually measure acoustic parameters multiple times during a trial-and-error based setup of the acoustic instruments. For example, displaying the indication of the estimated acoustic parameters assists the user in selecting initial configuration settings for the physical instruments that require fewer adjustments and hence fewer measurements. Performing fewer actual measurements tends to conserve power of a battery-operated device and prolong a usage time of the battery-operated device. Moreover, actual measurements of acoustic parameters may need to be performed on-device which may result in excessive heat generation specially on wearable electronic devices such as an HMD and potentially pose a health hazard for the user, whereas the acoustic simulation can be offloaded to another device such as a smartphone or a cloud computing platform where heat generation may be controlled and not pose a health risk to the user.

As represented by block 330a, in some implementations, the method 300 includes indicating areas of the physical environment where the estimated acoustic parameters are not within an acceptability range. In some implementations, the electronic device overlays an augmented reality (AR) mask onto an area of the physical environment where an estimated acoustic parameters are outside the acceptability range. The AR mask may include a colored mask, for example, a green AR mask for areas that are within an acceptability range, a yellow AR mask for areas that are near (e.g., within a threshold of) an upper bound or a lower bound of the acceptability range, and a red mask for areas that are outside the acceptability range. As an example, the electronic device 100 displays the loudness indication 134a in FIG. 1G in order to indicate that the area in front of the stage may not be loud enough.

As represented by block 330b, in some implementations, the method 300 includes recommending changes in configuration values for the virtual acoustic instruments. For example, as shown in FIG. 1H, the electronic device 100 displays the suggested sound configuration parameters 136b. In some implementations, the method 300 includes performing another acoustic simulation after the change in the configuration values has been performed. For example, referring to FIG. 1H, the acoustic configuration system 200 can update the acoustic simulation 130 in order to generate revised versions of the estimated acoustic parameters 132 after the user 102 selects the make suggested changes affordance 136c. In some implementations, recommending the changes includes recommending moving some of the virtual acoustic instruments to different locations. For example, as shown in FIG. 1M, the acoustic configuration system 200 recommends moving the virtual displays 160 closer to the stage. In some implementations, recommending the changes includes recommending changing settings of some of the virtual acoustic instruments. As an example, the electronic device may recommend reducing a gain of a virtual microphone in order to reduce estimated reverberation. In some implementations, the method 300 includes recommending, based on the estimated acoustic parameters, locations within the physical environment for placing physical acoustic instruments that correspond to the virtual acoustic instruments. For example, as shown in FIG. 1M, the electronic device 100 recommends moving the virtual displays 60 closer to the stage representation 112. As such, the displays 60 are to be placed closer to the stage 12.

As represented by block 330c, in some implementations, displaying the indication includes displaying a visualization of sound rays propagating through the physical environment. The visualization of the sound rays may allow the user of the electronic device to see which portions of the physical environment may have unacceptable sound quality. For example, the lack of sound rays in a portion of the physical environment indicates that the sound may not be sufficiently loud in that portion of the physical environment. In some implementations, sound rays of different colors may represent sounds with different frequencies. In such implementations, sound rays of multiple colors in a portion of the physical environment may indicate frequency interference that requires an appropriate EQ treatment (e.g., a filter to reduce an impact of interfering frequencies). The density of sound rays within a portion of the physical environment may indicate whether the sound is sufficiently loud (e.g., too many sound rays may indicate that the sound is too loud and too few sound rays may indicate that the sound is not loud enough).

As represented by block 330d, in some implementations, displaying the indication includes indicating areas of the physical environment where an estimated reverberation is greater than an acceptable level of reverberation or estimated echoes are greater than an acceptable level of echoes. For example, as shown in FIG. 1G, the electronic device 100 displays the reverberation indications 134b and 134c to indicate that the reverberation levels adjacent to the column 16 may be greater than an acceptable level of reverberation.

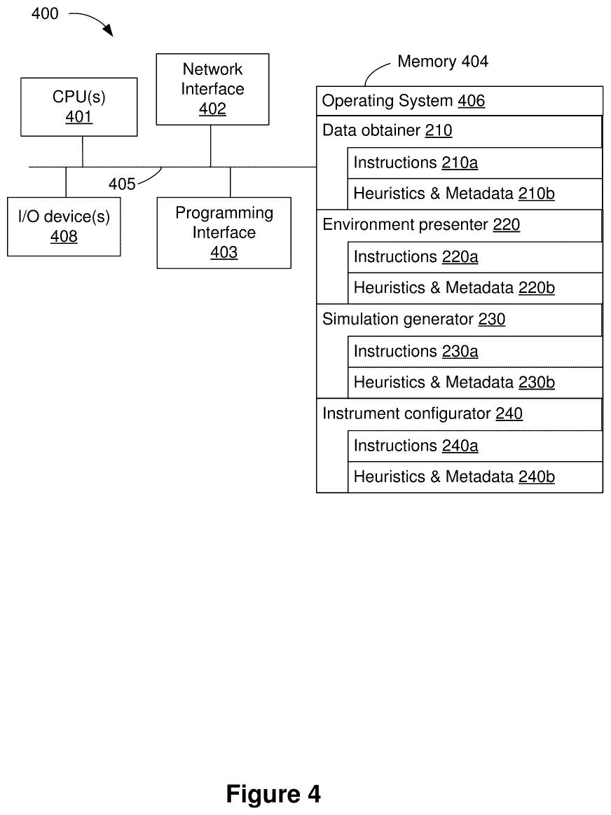

FIG. 4 is a block diagram of a device 400 in accordance with some implementations. In some implementations, the device 400 implements the electronic device 100 shown in FIGS. 1A-IN and/or the acoustic configuration system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (CPUs) 401, a network interface 402, a programming interface 403, a memory 404, one or more input/output (I/O) devices 408, and one or more communication buses 405 for interconnecting these and various other components.

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more CPUs 401. The memory 404 comprises a non-transitory computer readable storage medium.

In some implementations, the one or more I/O devices 408 include a display for displaying the environment representation 110 shown in FIG. 1B. In some implementations, the display includes an extended reality (XR) display. In some implementations, the display includes an opaque display. Alternatively, in some implementations, the display includes an optical see-through display. In some implementations, the one or more I/O devices 408 include an environmental sensor for capturing the environmental data 212 and/or the instrument data 214 shown in FIG. 2. For example, the one or more I/O devices 408 include an image sensor (e.g., a visible light camera and/or an infrared light camera) for capturing the image data 212a and/or a depth sensor (e.g., a depth camera) for capturing the depth data 212b shown in FIG. 2. In some implementations, the one or more I/O devices 408 include an audio sensor (e.g., a microphone) for receiving an audible signal and converting the audible signal into electronic signal data.

In some implementations, the memory 404 or the non-transitory computer readable storage medium of the memory 404 stores the following programs, modules and data structures, or a subset thereof including an optional operating system 406, the data obtainer 210, the environment presenter 220, the simulation generator 230 and the instrument configurator 240.

In various implementations, the data obtainer 210 includes instructions 210a, and heuristics and metadata 210b for obtaining the environmental data 212 and/or the instrument data 214 shown in FIG. 2. In some implementations, the environment presenter 220 includes instructions 220a, and heuristics and metadata 220b for presenting the pass-through 222 and overlaying the virtual instruments 224 onto the pass-through 222 shown in FIG. 2 . . . . In some implementations, the simulation generator 230 includes instructions 230a, and heuristics and metadata 230b for performing the simulation 232 in order to generate the estimated parameters 234 shown in FIG. 2 . . . . In some implementations, the instrument configurator 240 includes instructions 240a, and heuristics and metadata 240b for displaying the visual indicators 242 and providing the suggested configuration 244 shown in FIG. 2.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

In a live performance such as a concert, a show or a presentation, an audience member may be located in a portion of a physical environment where a sensory perception parameter (e.g., an acoustic parameter, a visual parameter, a haptic parameter and/or a smell parameter) is outside an acceptability range. For example, the sound level may be lower than a threshold sound level. As another example, a reverberation at that location may be greater than a threshold reverberation level. As yet another example, a lighting level may be outside an acceptable lighting range. As such, an experience of the audience member may be adversely impacted due to the sensory perception parameter being outside the acceptability range.

The present disclosure provides methods, systems, and/or devices for augmenting a portion of a physical environment with augmented content when a localized perceptual parameter is outside an acceptability range. The localized perceptual parameter may include a localized environmental parameter that provides an indication of how a person perceives (e.g., acoustically, optically, haptically and/or olfactorily) the environment around him/her. A device augments a physical environment with augmented content when the device is located within a portion of a physical environment where a localized environmental parameter breaches a threshold. The device can measure the localized environmental parameter using an on-device sensor.

The augmented content can include acoustic content. The device can measure a localized acoustic parameter (e.g., a sound level, for example, an amplitude and/or a frequency) based on audible signal data captured via a microphone. The device can play additional sounds either to enhance desirable sounds that are reaching the device and/or to cancel undesirable sounds being detected at the device. For example, the device can generate and play sounds that cancel an echo while still allowing the user to listen to live music that is being played.

The augmented content can include visual content. The device can measure a localized lighting parameter (e.g., an ambient light level) using an ambient light sensor. The device can display visual content either to enhance desirable visual effects and/or to reduce an impact of undesirable visual effects. For example, the device could increase a brightness of the display if the device is located in a portion of the physical environment that is too dull due to insufficient lighting.

The augmented content can include haptic content. The device can measure a localized haptic parameter (e.g., a frequency or intensity of vibrations) using a haptic sensor. The device can generate haptic responses to enhance desirable haptic effects and/or to cancel undesirable haptic effects. For example, if the user is sitting on a cushion that can vibrate, the device can increase the vibrations to provide an effect of more bass or decrease the vibrations to compensate for too much bass.

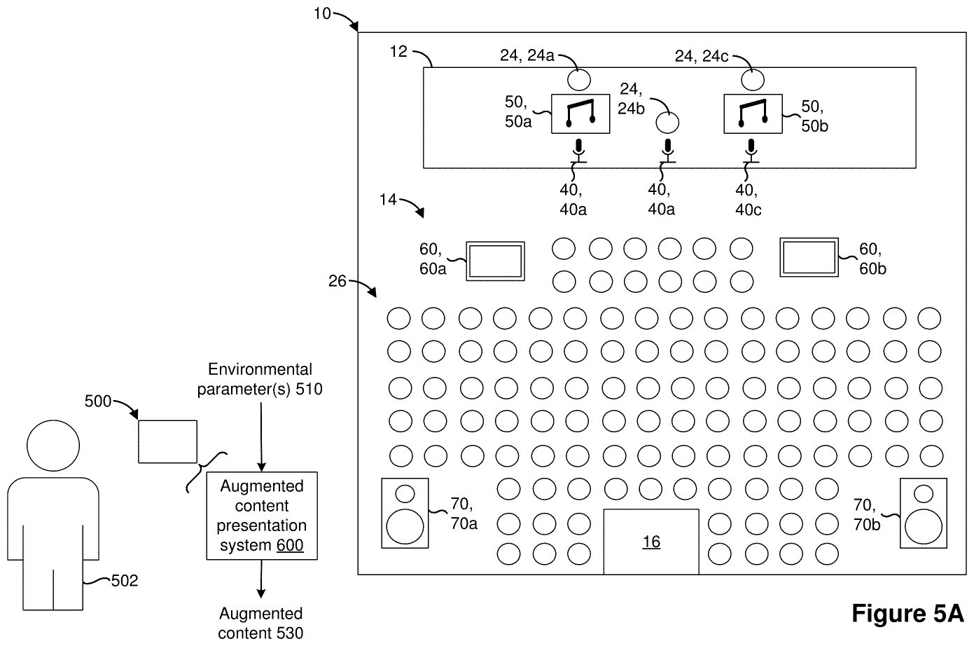

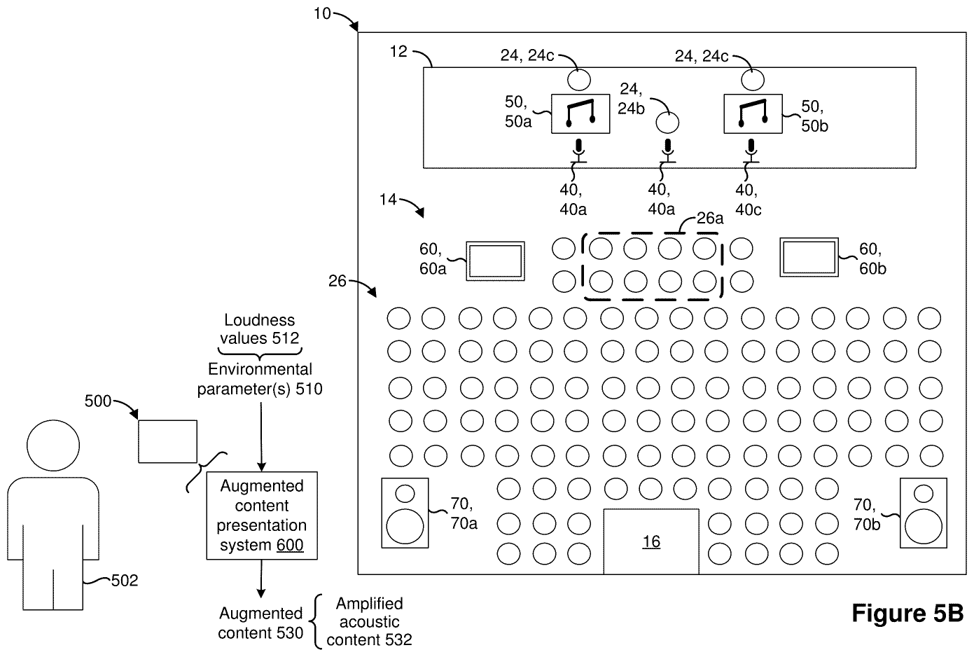

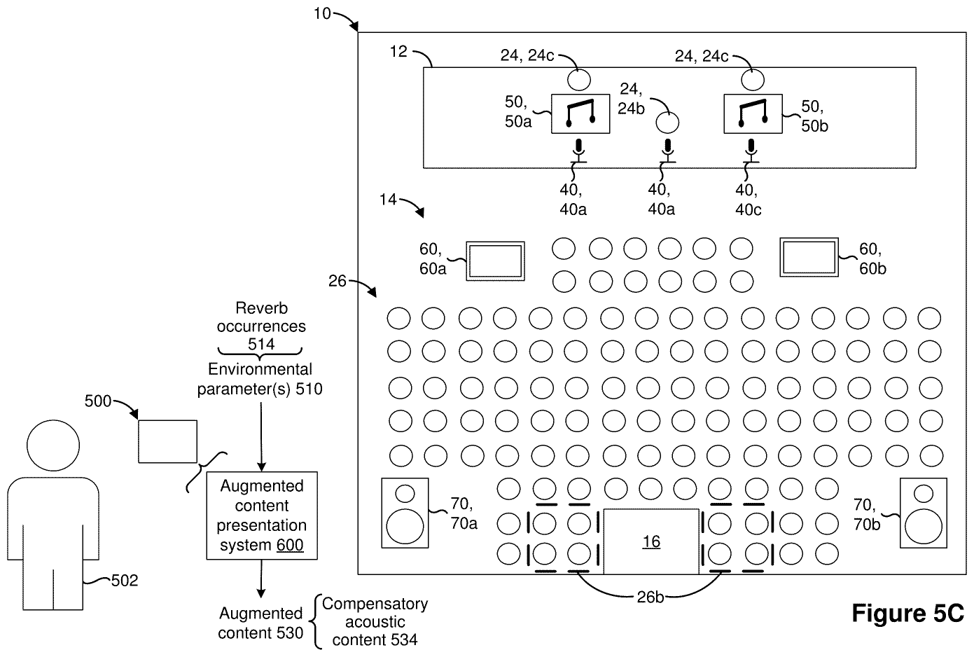

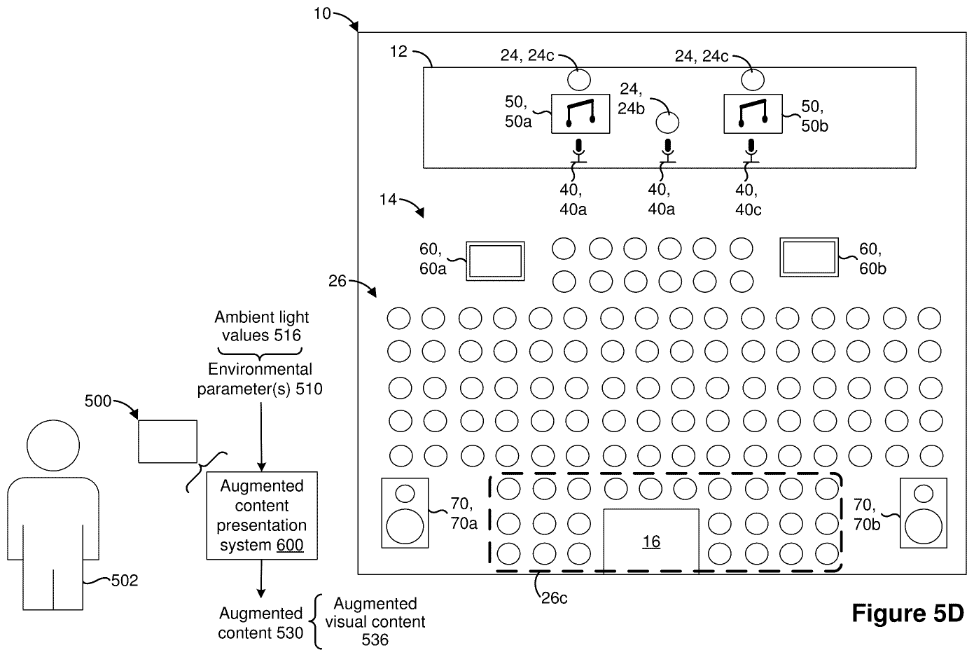

FIG. 5A is a diagram that illustrates the physical environment 10 with various physical instruments placed throughout the physical environment 10. The physical instruments are placed at the same locations as the corresponding virtual instruments shown in FIG. 1E. For example, the microphones 40 are placed towards the front of the stage 12 similar to how the virtual microphone 140 are placed towards the front of the stage representation 112 in FIG. 1E. The musical instruments 50 are placed at the same locations as the virtual musical instruments 150 shown in FIG. 1E. The displays 60 are placed at the same locations as the virtual displays 60 shown in FIG. 1E. The speakers 70 are placed at the same locations as the virtual speakers 170 shown in FIG. 1E. FIG. 5A further illustrates performers 24 that are situated at the same locations as the virtual performers 124 shown in FIG. 1E. For example, a first performer 24a is in position to play the first musical instrument 50a similar to the first virtual performer 124a being in position to play the first virtual musical instrument 150a in FIG. 1E, a second performer 24b is in position to sing at the second microphone 40b similar to the second virtual performer 124b being in position to sing at the second virtual microphone 140b, and a third performer 24c is in position to play the second musical instrument 50b similar to the third virtual performer 124c being in position to play the second virtual instrument 150b. FIG. 5A additionally illustrates audience members 26 that are situated within the physical environment 10 in the same positions as the virtual audience members 126 shown in FIG. 1E.

FIG. 5A illustrates an electronic device 500 that is being used by a user 502. In some implementations, many of the audience members 26 have electronic devices. In some implementations, the user 502 represents a particular one of the audience members 26 and the electronic device 500 represents the electronic device of that particular audience member 26. Alternatively, in some implementations, the electronic device 500 operates as a master device and electronic devices of the audience members 26 operate as slave devices, and the master device controls presentation of content on the slave devices after obtaining informed consent during a live performance in the physical environment 10. In some implementations, the electronic device 500 includes a portable electronic device such as smartphone or a tablet. In some implementations, the electronic device 500 includes a wearable computing device such as an HMD or a watch. For example, in some implementations, many of the audience members 26 wear HMDs that present content during the live performance.

In various implementations, the electronic device 500 includes an augmented content presentation system 600 (“system 600”, hereinafter for the sake of brevity). In some implementations, the system 600 obtains a set of one or more environmental parameters 510 (“environmental parameter 510”, hereinafter for the sake of brevity) that indicate a sensory condition at a location within the physical environment 10. In some implementations, the electronic device 500 utilizes an on-device sensor to measure the environmental parameter 510 and the environmental parameter 510 indicates a sensory condition at a location of the electronic device 500 within the physical environment 10. Alternatively, in a master-slave configuration, the electronic device 500 receives the environmental parameter 510 from an electronic device of a particular one of the audience members 26 and the environmental parameter 510 indicates a sensory condition at a location of the electronic device being used by that particular audience member 26.

In some implementations, the environmental parameter 510 includes an acoustic parameter. In some implementations, the acoustic parameter includes a loudness value that indicates a loudness of audible signals received at a particular location within the physical environment 10. In some implementations, the acoustic parameter includes a frequency response measured at the particular location within the physical environment 10. In some implementations, the acoustic parameter indicates an occurrence of an echo or a reverberation at the particular location within the physical environment 10. In some implementations, the acoustic parameter indicates a sound quality value that characterizes a quality of a sound detected at the particular location within the physical environment 10.

In some implementations, the environmental parameter 510 includes a visual parameter. In some implementations, the visual parameter includes an ambient light value that indicates a brightness level at the particular location within the physical environment 10. In some implementations, the visual parameter includes a color value that indicates a color of a light detected at the particular location within the physical environment 10. In some implementations, the visual parameter includes a frequency of a light detected at the particular location within the physical environment 10.

In some implementations, the environmental parameter 510 includes a haptic parameter. In some implementations, the haptic parameter indicates a level of vibrations detected at the particular location within the physical environment 10. In some implementations, the haptic parameter indicates types of vibrations detected at the particular location. In some implementations, the haptic parameter indicates a frequency and/or an intensity of vibrations detected at the particular location.

In some implementations, the system 600 triggers presentation of augmented content 530 based on the environmental parameter 510. In some implementations, the system 600 determines to present the augmented content 530 when the environmental parameter 510 is outside an acceptable range. In various implementations, presenting the augmented content 530 tends to enhance the sensory condition at the particular location within the physical environment 10.

Referring to FIG. 5B, in some implementations, the environmental parameter 510 includes one or more loudness values 512 that indicate loudness of sounds in an area of the physical environment where a first subset 26a of the audience members 26 are situated. The system 600 determines whether the loudness values 512 are within an acceptable range of loudness values. In the example of FIG. 5B, the system 600 determines that the loudness values 512 are outside of the acceptable range of loudness values. For example, the system 600 determines that the loudness values 512 are below a loudness threshold (e.g., the sound is not loud enough where the first subset 26a of the audience members 26 are seated). As such, the system 600 determines to present amplified acoustic content 532 in order to compensate for the low loudness in the area where the first subset 26a of the audience members 26 are seated. In some implementations, the amplified acoustic content 532 is an amplified version of the live performance occurring in the physical environment 10. The system 600 may send an instruction to an electronic device of each audience member in the first subset 26a to present the amplified acoustic content 532. Presenting the amplified acoustic content 532 compensates for the relatively low loudness of the sounds in the area where the first subset 26a is seated.

While FIG. 5B illustrates an example where audio from the live performance is amplified, in some implementations, audio from the live performance may be modified in another manner. For example, in some implementations, the loudness values 512 may be greater than a loudness threshold. In such implementations, the augmented content 530 may dampen the audio from the live performance instead of further amplifying the audio. In some implementations, the audience members in the first subset 26a may be wearing noise-canceling headphones that can output a dampened version of the audio from the physical environment 10. For example, the noise-canceling headphones may lower an amplitude of the audio from the physical environment 10.

Referring to FIG. 5C, in some implementations, the environmental parameter 510 indicates that an area of the physical environment 10 where a second subset 26b of the audience members 26 are seated is associated with reverberance occurrences 514. The system 600 determines whether the reverberance occurrences 514 are greater than a reverberance threshold. In the example of FIG. 5C, the system 600 determines that the reverberance occurrences 514 are greater than the reverberance threshold. In response to determining that the reverberance occurrences 514 are greater than the reverberance threshold, the system 600 presents compensatory acoustic content 534 that cancels the reverberances in the areas where the second subset 26b of the audience members 26 are seated. More generally, in various implementations, the augmented content 530 includes audio content that cancels an undesirable portion of audio being detected within a portion of the physical environment 10 while allowing a desirable portion of the audio to be heard by audience members 26 seated in that portion of the physical environment 10.

Referring to FIG. 5D, in some implementations, the environmental parameter 510 indicates that an area of the physical environment 10 where a third subset 26c of the audience members 26 are seated is associated with ambient light values 516. The system 600 determines whether the ambient light values 516 are within an acceptable range of ambient light values. For example, the system 600 determines whether the ambient light values 516 are greater than or less than a brightness threshold. If the ambient light values 516 are less than the brightness threshold, the system 600 generates augmented visual content 536 that darkens the area of the physical environment 10 where the third subset 26c of audience members 26 are located (e.g., the system 600 decreases a brightness level of the see-through display) If the ambient light values 516 are greater than the brightness threshold, the augmented visual content 536 brightens the area of the physical environment 10 where the third subset 26c of the audience members 26 are located (e.g., the system 600 increases the brightness level of the see-through display).

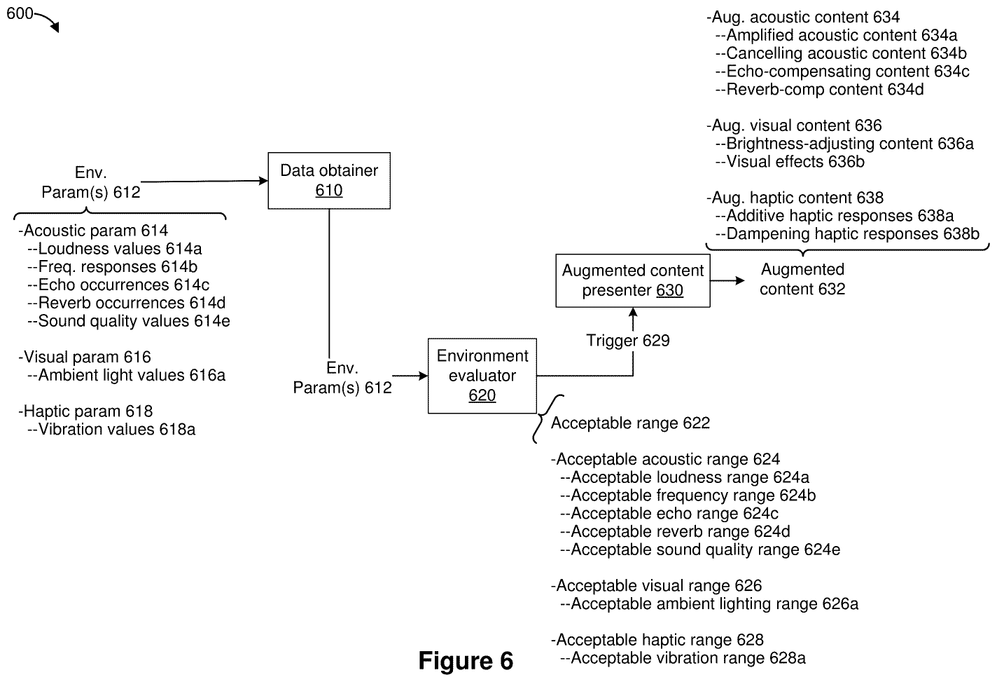

FIG. 6 illustrates an example implementation of the system 600. In various implementations, the system 600 includes a data obtainer 610, an environment evaluator 620 and an augmented content presenter 630. In some implementations, the data obtainer 610 obtains environmental parameters 612 (e.g., the environmental parameter 510 shown in FIGS. 5A-5D) that indicate a sensory condition at a particular location within a physical environment. In some implementations, the environmental parameters 612 include perceptual values that indicate how a person perceives (e.g., hears, views, feels and/or smells) a portion of the physical environment.

In some implementations, the environmental parameters 612 include acoustic parameters 614 that indicate an acoustic condition of a particular area within the physical environment. In some implementations, the acoustic parameters 614 include loudness values 614a (e.g., the loudness values 512 shown in FIG. 5B) that indicate how loud the area of the physical environment sounds. The loudness values 614a may include amplitude values. In some implementations, the acoustic parameters 614 include frequency responses 614b that indicate frequencies encountered within the area of the physical environment. In some implementations, the acoustic parameters 614 indicate echo occurrences 614c or reverberation occurrences 614d (e.g., the reverberation occurrences 514 shown in FIG. 5C) within the area of the physical environment. In some implementations, the acoustic parameters 614 include sound quality values 614e that indicate a quality of the sound detected within the area of the physical environment.

In some implementations, the environmental parameters 612 include visual parameters 616 that indicate a visual condition (e.g., an optical condition or a viewing condition) of a particular area within the physical environment. In some implementations, the visual parameters 616 include ambient light values 616a. The ambient light values 616a indicate how bright or dull a corresponding portion of the physical environment is. In some implementations, the visual parameters 616 indicate an intensity, a color and/or a frequency of light in the particular area of the physical environment.

In some implementations, the environmental parameters 612 include haptic parameters 618 that indicate a haptic condition of a particular area within the physical environment. In some implementations, the haptic parameters 618 include vibration values 618a that indicate a strength of vibrations in the particular area of the physical environment. In some implementations, the haptic parameters 618 indicate an intensity and/or a frequency of the vibrations in the particular area of the physical environment.

In various implementations, the environment evaluator 620 evaluates the sensory condition of a particular portion of a physical environment by comparing the environmental parameters 612 with an acceptable range 622. In some implementations, the environment evaluator 620 determines whether the environmental parameters 612 are within the acceptable range 622. If the environmental parameters 612 are not within the acceptable range 622, the environment evaluator 620 generates a trigger 629 for the augmented content presenter 630 to present augmented content 632 in order to enhance the sensory condition of the portion of the physical environment.

In some implementations, the acceptable range 622 includes an acceptable acoustic range 624. The environment evaluator 620 determines whether the acoustic parameters 614 are within or outside the acceptable acoustic range 624. If the acoustic parameters 614 are outside the acceptable acoustic range 624, the trigger 629 causes the augmented content presenter 630 to present augmented acoustic content 634 in order to improve an acoustic condition of the portion of the physical environment. In some implementations, the environment evaluator 620 determines whether the loudness values 614a are within an acceptable loudness range 624a. If the loudness values 614a are below a lower end of the acceptable loudness range 624a, the augmented content presenter 630 presents amplified acoustic content 634a (e.g., the amplified acoustic content 532 shown in FIG. 5B).

In some implementations, the environment evaluator 620 determines whether the frequency responses 614b indicate frequencies that are within or outside an acceptable frequency range 624b. If the frequencies indicated by the frequency responses 614b are outside the acceptable frequency range 624b, the augmented content presenter 630 can present cancelling acoustic content 634b that cancels frequencies outside the acceptable frequency range 624b.

In some implementations, the environment evaluator 620 determines whether the echo occurrences 614c indicate an occurrence of echoes that is within or outside an acceptable echo range 624c. For example, the environment evaluator 620 determines whether a number, a duration and/or an intensity of the echoes is within or outside the acceptable echo range 624c. If the echo occurrences 614c are outside the acceptable echo range 624c, the augmented content presenter 630 presents echo-compensating content 634c in order to reduce an impact of the echoes (e.g., in order to reduce the number, the duration and/or the intensity of the echoes).

In some implementations, the environment evaluator 620 determines whether the reverberation occurrences 614d indicate an occurrence of reverberations that is within or outside an acceptable reverberation range 624d. For example, the environment evaluator 620 determines whether a number, a duration and/or an intensity of the reverberations is within or outside the acceptable reverberation range 624d. If the reverberation occurrences 614d are outside the acceptable reverberation range 624d, the augmented content presenter 630 presents reverberation-compensating content 634d in order to reduce an impact of the reverberations (e.g., in order to reduce the number, the duration and/or the intensity of the reverberations).

In some implementations, the environment evaluator 620 determines whether the sound quality values 614e are within or outside an acceptable sound quality range 624e. If the sound quality values 614e are outside the acceptable sound quality range 624e, the augmented content presenter 630 presents the augmented acoustic content 634 in order to change the sound quality values 614e to revised sound quality values that are within the acceptable sound quality range 624e.

In some implementations, the acceptable range 622 includes an acceptable visual range 626. The environment evaluator 620 determines whether the visual parameters 616 are within or outside the acceptable visual range 626. If the visual parameters 616 are outside the acceptable visual range 626, the trigger 629 causes the augmented content presenter 630 to present augmented visual content 636 (e.g., the augmented visual content 536 shown in FIG. 5D) in order to improve an optical condition of the portion of the physical environment. In some implementations, the environment evaluator 620 determines whether the ambient light values 616a are within an acceptable ambient lighting range 626a. If the ambient light values 616a are outside the acceptable ambient lighting range 626a, the augmented content presenter 630 presents brightness-adjusting content 636a. If the ambient light values 616a are below a lower end of the acceptable ambient lighting range 626a, the brightness-adjusting content 636a may include a brighter version of pass-through content which has the effect of increasing a brightness of the environment that the user sees through the display. By contrast, if the ambient light values 616a are greater than an upper end of the acceptable ambient lighting range 626a, the brightness-adjusting content 636a may include a duller version of the pass-through content which has the effect of decreasing a brightness of the environment that the user sees through the display.

In some implementations, the augmented visual content 636 includes visual effects 636b that tend to enhance an optical condition in the portion of the environment. As an example, referring to FIG. 5D, the portion of the physical environment 10 where the third subset 26c of the audience members 26 are seated may have monotone lights instead of colored lights like the area closer to the stage 12 where the first subset 26a (shown in FIG. 5B) is seated. In this example, the augmented content presenter 630 may trigger HMDs worn by the third subset 26c to display the visual effects 636b with colored lighting thereby providing the third subset 26c the same visual experience as the first subset 26a. In some implementations, the visual effects 636b may include optical illusions and/or animations that enhance a visual experience of the viewers. For example, the visual effects 636b provided to devices (e.g., HMDs) of the third subset 26c (shown in FIG. 5D) may include bigger representations of the performers 24 in order to provide an illusion that the performers 24 are closer to the third subset 26c than the performers 24 actually are (e.g., the visual effects 636b may make the performers 24 appear as large as the performers 24 would appear to the first subset 26a of the audience members 26).

In some implementations, the acceptable range 622 includes an acceptable haptic range 628. The environment evaluator 620 determines whether the haptic parameters 618 are within or outside the acceptable haptic range 628. If the haptic parameters 618 are outside the acceptable haptic range 628, the trigger 629 causes the augmented content presenter 630 to present augmented haptic content 638 in order to improve a haptic condition of the portion of the physical environment. In some implementations, the environment evaluator 620 determines whether the vibration values 618a are within an acceptable vibration range 628a. If the vibration values 618a are below a lower end of the acceptable vibration range 628a, the augmented haptic content 638 includes additive haptic responses 638a which has the effect of increasing vibrations in a portion of the environment where the user is seated (e.g., by vibrating a haptic seat that the user is sitting on, for example, by applying vibration-amplifying haptic responses via the haptic seat). By contrast, if the vibration values 618a are greater than an upper end of the acceptable vibration range 628a, the augmented haptic content 638 includes dampening haptic responses 638b which has the effect of decreasing vibrations in the portion of the physical environment (e.g., by applying vibration-cancelling haptic responses via the haptic seat).

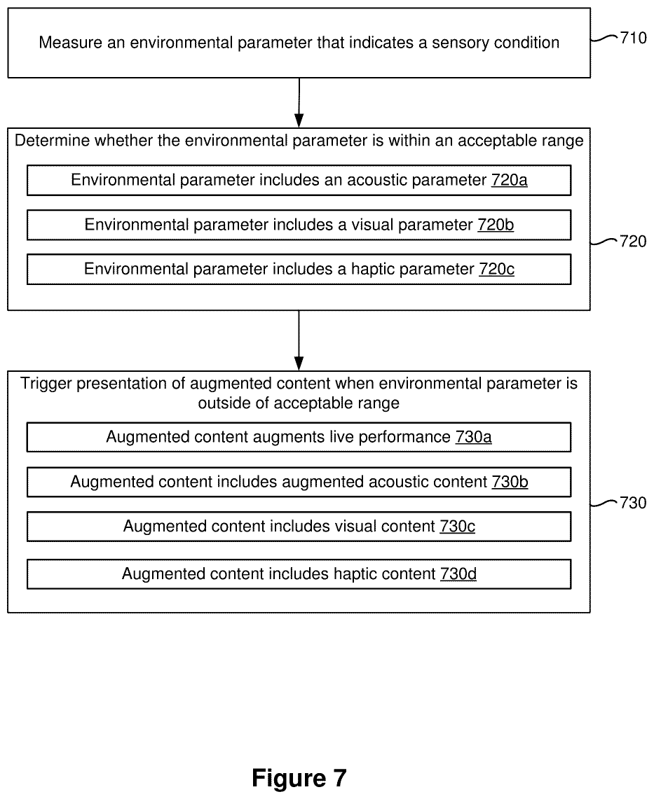

FIG. 7 is a flowchart representation of a method 700 for presenting augmented content in a portion of a physical environment. In various implementations, the method 700 is performed by the electronic device 500 shown in FIGS. 5A-5D and/or the system 600 shown in FIGS. 5A-6. In some implementations, the method 700 is performed by processing logic, including hardware, firmware, software, or a combination thereof. In some implementations, the method 700 is performed by a processor executing code stored in a non-transitory computer-readable medium (e.g., a memory).

As represented by block 710, in various implementations, the method 700 includes measuring an environmental parameter that indicates a sensory condition at a location of the electronic device within a physical environment. For example, as shown in FIG. 5A, the system 600 obtains the environmental parameter 510. In some implementations, the electronic device obtains the environmental parameter from another device that measures the environmental parameter. In some implementations, the electronic device obtains a first environmental parameter that indicates a first sensory condition at a first location within the physical environment, a second environmental parameter that indicates a second sensory condition at a second location within the physical environment, . . . , and an nth environmental parameter that indicates an nth sensory condition at an nth location within the physical environment.

In some implementations, the environmental parameter includes a perceptual value that indicates how a person at the location of the electronic device perceives the physical environment. In some implementations, the environmental parameter includes an acoustic parameter that indicates an acoustic condition of a portion of the physical environment (e.g., the acoustic parameters 614 shown in FIG. 6). For example, the acoustic parameter indicates how loud sounds arriving at the location may sound to a person at the location (e.g., the loudness values 614a), frequencies of sounds arriving at the location (e.g., the frequency responses 614b), whether or not there are echoes at the location (e.g., the echo occurrences 614c), whether or not there are reverberations at the location (e.g., the reverberation occurrences 614d) and/or sound quality at the location (e.g., the sound quality values 614e).

In some implementations, the environmental parameter includes a visual parameter that indicates a visual condition (e.g., an optical condition) of a portion of the physical environment (e.g., the visual parameters 616 shown in FIG. 6). For example, the visual parameter indicates a brightness level of a portion of the physical environment where the electronic device is located (e.g., the ambient light values 616a). In some implementations, the visual parameter indicates an amount of visual noise in the portion of the physical environment (e.g., a variance in colors of light arriving at the location of the electronic device).

In some implementations, the environmental parameter includes a haptic parameter that indicates a haptic condition (e.g., a vibrational condition) of a portion of the physical environment (e.g., the haptic parameters 618 shown in FIG. 6). For example, the haptic parameter indicates a level of vibrations at a portion of the physical environment where the electronic device is located (e.g., the vibration values 618a).

As represented by block 720, in some implementations, the method 700 includes determining whether the environmental parameter is within an acceptable range. For example, as shown in FIG. 6, the environment evaluator 620 determines whether or not the acoustic parameter 614 is within the acceptable range 622. In some implementations, the method 700 includes determining to present augmented content when the environmental parameter is outside of the acceptable range. For example, as shown in FIG. 6, the environment evaluator 620 generates the trigger 629 for the augmented content presenter 630 to present the augmented content 632 when the environmental parameter 612 is outside the acceptable range 622.

As represented by block 720a, in some implementations, the environmental parameter includes an acoustic parameter and the acceptable range includes an acceptable acoustic range. For example, as shown in FIG. 6, the environmental parameters 612 include the acoustic parameter 614 (e.g., the loudness values 614a, the frequency responses 614b, the echo occurrences 614c, the reverberation occurrences 614d and/or the sound quality values 614e), and the acceptable range 622 includes the acceptable acoustic range 624 (e.g., the acceptable loudness range 624a, the acceptable frequency range 624b, the acceptable echo range 624c, the acceptable reverberation range 624d and/or the acceptable sound quality range 624e).

As represented by block 720b, in some implementations, the environmental parameter includes a visual parameter and the acceptable range includes an acceptable lighting level. For example, as shown in FIG. 6, the environmental parameters 612 include the visual parameter 616 (e.g., the ambient light values 616a) and the acceptable range 622 includes the acceptable visual range 626 (e.g., the acceptable ambient lighting range 626a).

As represented by block 720c, in some implementations, the environmental parameter includes a haptic parameter and the acceptable range includes an acceptable haptic level at the location. For example, as shown in FIG. 6, the environmental parameters 612 include the haptic parameter 618 (e.g., the vibration values 618a) and the acceptable range 622 includes the acceptable haptic range 628 (e.g., the acceptable vibration range 628a).

As represented by block 730, in various implementations, the method 700 includes, in response to determining that the environmental parameter is not within the acceptable range, triggering presentation of augmented content in order to enhance the sensory condition at the location of the electronic device. For example, as shown in FIG. 6, the augmented content presenter 630 triggers presentation of the augmented content 632 when one or more of the environmental parameters 612 is outside the acceptable range 622. In various implementations, presenting the augmented content enhances the sensory condition at the location by improving an acoustic condition, an optical condition and/or a haptic condition of the location. In various implementations, the sensory condition is below a threshold prior to the presentation of the augmented content and presenting the augmented content improves the sensory condition such that the sensory condition becomes greater than the threshold.

As represented by block 730a, in some implementations, the augmented content augments a live performance in the physical environment. For example, as shown in FIG. 5A, the augmented content 530 augments the live performance being delivered by the performers 24. In some implementations, the augmented content improves a perception of the live performance by some of the audience members. In some implementations, the augmented content augments the live performance acoustically, visually, haptically (e.g., by outputting haptic responses) and/or olfactorily (e.g., by diffusing odors).

As represented by block 730b, in some implementations, the augmented content includes acoustic content. For example, as shown in FIG. 6, the augmented content 632 includes the augmented acoustic content 634. In some implementations, triggering presentation of the augmented content includes outputting an audible signal that cancels an undesirable audible signal received at the electronic device. For example, as shown in FIG. 6, in some implementations, the augmented acoustic content 634 includes cancelling acoustic content 634b. In some implementations, triggering presentation of the augmented content includes outputting an audible signal that boosts a desirable audible signal received at the electronic device. For example, as shown in FIG. 5B, the system 600 presents the amplified acoustic content 532. In some implementations, the acoustic content compensates for reverberations at the location of the electronic device. For example, as shown in FIG. 6, the augmented acoustic content 634 may include reverberation-compensating acoustic content. In some implementations, the acoustic content amplifies an audible signal received at the electronic device. For example, as shown in FIG. 6, the augmented acoustic content 634 may include amplified acoustic content 634a.

In some implementations, triggering presentation of the augmented content includes causing another electronic device to output an audible signal. For example, the electronic device may operate as a master device that triggers various other devices operating as slave devices to play different augmented content. As an example, referring to FIGS. 5B-5D, the electronic device 500 can operate as a master device and instruct devices for the first subset 26a of the audience members 26 to play the amplified acoustic content 532, instruct devices for the second subset 26b of the audience members 26 to play the compensatory acoustic content 534 and instruct HMDs worn by the third subset 26c of the audience members to the play the augmented visual content 536.

As represented by block 730c, in some implementations, the augmented content includes visual content. For example, as shown in FIG. 5D, the augmented content 530 provided to devices of the third subset 26c of the audience members 26 includes the augmented visual content 536. In some implementations, triggering presentation of the augmented content includes increasing a brightness of the display in order to compensate for low ambient lighting at the location of the electronic device. In some implementations, triggering presentation of the augmented content includes decreasing a brightness of the display in order to compensate for high ambient lighting at the location of the electronic device. For example, as shown in FIG. 6, the augmented visual content 636 includes the brightness-adjusting content 636a. In some implementations, triggering presentation of the augmented content includes displaying visual effects that correspond to an audible signal received at the electronic device. For example, as shown in FIG. 6, the augmented visual content 636 may include the visual effects 636b. In some implementations, the visual effects match an acoustic characteristic of an audible signal received at the location of the electronic device. For example, if the audible signal corresponds to a song with a relatively fast beat, the visual effects may include displaying disco-style flashing lights.

In some implementations, triggering presentation of the augmented content includes causing another electronic device to display visual content. For example, as described in relation to FIG. 5D, the electronic device 500 operates as a master device that instructs HMDs worn by the third subset 26c of the audience members 26 to display the augmented visual content 536.

As represented by block 730d, in some implementations, the augmented content includes haptic content. For example, as shown in FIG. 6, the augmented content 632 may include augmented haptic content 638. In some implementations, triggering presentation of the augmented content includes outputting haptic responses via a haptic device based on an audible signal data received at the electronic device. For example, the haptic content includes vibrations that are exhibited by a device that includes a motor attached to an unbalanced load. In some implementations, triggering presentation of the augmented content includes generating haptic responses to cancel haptic responses detected at the location of the electronic device. For example, as shown in FIG. 6, the augmented haptic content 638 may include additive haptic responses 638a or dampening haptic responses 638b.

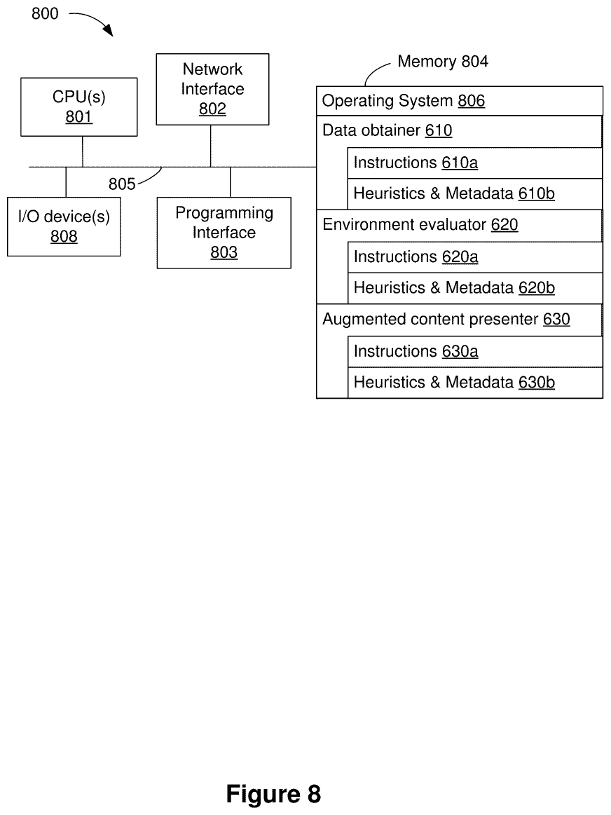

FIG. 8 is a block diagram of a device 800 in accordance with some implementations. In some implementations, the device 800 implements the electronic device 500 shown in FIGS. 5A-5D and/or the augmented content presentation system 600 shown in FIGS. 5A-6. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units (CPUs) 801, a network interface 802, a programming interface 803, a memory 804, one or more input/output (I/O) devices 808, and one or more communication buses 805 for interconnecting these and various other components.

In some implementations, the network interface 802 is provided to, among other uses, establish and maintain a metadata tunnel between a cloud hosted network management system and at least one private network including one or more compliant devices. In some implementations, the one or more communication buses 805 include circuitry that interconnects and controls communications between system components. The memory 804 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 804 optionally includes one or more storage devices remotely located from the one or more CPUs 801. The memory 804 comprises a non-transitory computer readable storage medium.

In some implementations, the one or more I/O devices 808 include a speaker for outputting the augmented acoustic content 634, a display for displaying the augmented visual content 636 and/or a haptic device for outputting the augmented haptic content 638 shown in FIG. 6. In some implementations, the display includes an extended reality (XR) display. In some implementations, the display includes an opaque display. Alternatively, in some implementations, the display includes an optical see-through display. In some implementations, the one or more I/O devices 808 include an environmental sensor for capturing the environmental parameter(s) 612 shown in FIG. 6. For example, the one or more I/O devices 808 include a microphone for capturing the acoustic parameters 614, an image sensor (e.g., a visible light camera and/or an infrared light camera) for capturing the visual parameter(s) 616, and/or a haptic sensor for capturing the haptic parameters 618.

In some implementations, the memory 804 or the non-transitory computer readable storage medium of the memory 804 stores the following programs, modules and data structures, or a subset thereof including an optional operating system 806, the data obtainer 610, the environment evaluator 620 and the augmented content presenter 630.

In various implementations, the data obtainer 610 includes instructions 610a, and heuristics and metadata 610b for obtaining the environmental parameter(s) 612 shown in FIG. 6. In some implementations, the environment evaluator 620 includes instructions 620a, and heuristics and metadata 620b for evaluating the environmental parameter(s) 612 in relation to the acceptable range 622 shown in FIG. 6. In some implementations, the augmented content presenter 630 includes instructions 630a, and heuristics and metadata 630b for triggering presentation of the augmented content 632 shown in FIG. 6.

It will be appreciated that FIG. 8 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 8 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at an electronic device including a non-transitory memory, one or more processors, a display and an environmental sensor:
measuring an environmental parameter that indicates a sensory condition at a location of the electronic device within a physical environment;
determining whether the environmental parameter is within an acceptable range; and
in response to determining that the environmental parameter is not within the acceptable range, triggering presentation of augmented content in order to enhance the sensory condition at the location of the electronic device.

2. The method of claim 1, wherein the augmented content includes a combination of acoustic content, visual content and haptic content.

3. The method of claim 1, wherein the augmented content augments a live performance in the physical environment.

4. The method of claim 1, wherein triggering presentation of the augmented content comprises outputting an audible signal that cancels an undesirable audible signal received at the electronic device and boosts a desirable audible signal received at the electronic device.

5. The method of claim 1, wherein triggering presentation of the augmented content comprises:
increasing a brightness of the display in order to compensate for low ambient lighting at the location of the electronic device; or
decreasing the brightness of the display in order to compensate for high ambient lighting at the location of the electronic device.

6. The method of claim 1, wherein the environmental parameter includes an acoustic parameter and the acceptable range includes an acceptable acoustic range.

7. The method of claim 1, wherein the environmental parameter includes a visual parameter and the acceptable range includes an acceptable lighting level.

8. The method of claim 1, wherein triggering presentation of the augmented content comprises displaying visual effects that correspond to an audible signal received at the electronic device.

9. A device comprising:
a display;
an environmental sensor;
one or more processors;
a non-transitory memory; and
one or more programs stored in the non-transitory memory, which, when executed by the one or more processors, cause the device to:
measure an environmental parameter that indicates a sensory condition at a location of the electronic device within a physical environment;
determine whether the environmental parameter is within an acceptable range; and
in response to determining that the environmental parameter is not within the acceptable range, trigger presentation of augmented content in order to enhance the sensory condition at the location of the electronic device.

10. The device of claim 9, wherein triggering presentation of the augmented content comprises outputting an audible signal that cancels an undesirable audible signal received at the electronic device or amplifies a desirable audible signal received at the electronic device.

11. The device of claim 9, wherein the augmented content compensates for reverberation at the location of the electronic device.

12. The device of claim 9, wherein triggering presentation of the augmented content comprises:
outputting haptic responses via a haptic device based on an audible signal data received at the electronic device; or
generating haptic responses to cancel haptic responses detected at the location of the electronic device.

13. The device of claim 9, wherein the environmental parameter includes a visual parameter and the acceptable range includes an acceptable lighting level.

14. A non-transitory memory storing one or more programs, which, when executed by one or more processors of a device with an environmental sensor and a display, cause the device to:
measure an environmental parameter that indicates a sensory condition at a location of the electronic device within a physical environment;
determine whether the environmental parameter is within an acceptable range; and
in response to determining that the environmental parameter is not within the acceptable range, trigger presentation of augmented content in order to enhance the sensory condition at the location of the electronic device.

15. The non-transitory memory of claim 14, wherein the augmented content includes a combination of acoustic content, visual content and haptic content.

16. The non-transitory memory of claim 14, wherein triggering presentation of the augmented content comprises causing another electronic device to output an audible signal or display visual content.

17. The non-transitory memory of claim 14, wherein triggering presentation of the augmented content comprises displaying visual effects that correspond to an audible signal received at the electronic device.

18. The non-transitory memory of claim 14, wherein triggering presentation of the augmented content comprises:
increasing a brightness of the display in order to compensate for low ambient lighting at the location of the electronic device; and
decreasing the brightness of the display in order to compensate for high ambient lighting at a second location of the electronic device.

19. The non-transitory memory of claim 14, wherein the environmental parameter includes a haptic parameter and the acceptable range includes an acceptable haptic level at the location.

20. The non-transitory memory of claim 14, wherein the augmented content augments a live performance in the physical environment.
